(19) United States
(12) Patent Application Publication
(10) Pub. No.: US 2014/0298151 A1
(43) Pub. Date: Oct. 2, 2014

(54) Creation and distribution of forms

(71) Applicant: FitzForm LLC, San Mateo, CA (US)

(72) Inventor: Mark Fitzpatrick, San Mateo, CA (US)

(73) Assignee: FitzForm LLC, San Mateo, CA (US)

(21) Appl. No.: 13/986,539

(22) Filed: May 13, 2013

Related U.S. Application Data
(60) Provisional application No. 61/688,317, filed on May 11, 2012.

(51) Int. Cl. G06F 17/24

(52) U.S. Cl. CPC G06F 17/243
USPC 715/226

(57) ABSTRACT

A method may include: retrieving a particular blank universal form based on a universal form template, the particular blank universal form having a universal form identifier, and the particular blank universal form created by a universal form creator; providing the particular blank universal form to a universal form filler; receiving a verified form from a universal form filler, the verified form corresponding to the particular blank universal form; and providing the verified form to the universal form creator.

### CLAIM OF PRIORITY

This application claims priority to and incorporates by reference U.S. Patent Application Ser. No. 61/688,317, filed May 11, 2012, entitled, “Preparation of Forms.”

### BACKGROUND

Forms play an important information-gathering role for organizations, whether large or small. Organizations may use forms to automate collection of information they deem relevant from people, including their customers. Forms have several advantages over prior systems that required people to write information out in narrative form. More specifically, forms allow organizations to gather uniform data from people, allow organizations to collect information in writing, allow organizations to tell or remind people what information to supply, and reduce the amount that people have to write in order to supply information to an organization. As the data gathered using a form may have a degree of uniformity, forms may also simplify entry of data into data processing systems, and may allow organizations to efficiently incorporate gathered information into the organization's work processes.

Forms may be in paper or electronic format. A paper form is often a piece of paper having fields for people to manually enter data with a pen or a typewriter. In times past, paper forms were typically printed in a print shop. However, paper forms may now be printed using a printer coupled to a digital device. An electronic form is an electronic document that can be viewed by a digital device. To enter data into an electronic form, a person may display the form on his or her digital device and may fill the form out using the keyboard of the digital device. Electronic forms may take many formats, from documents that are displayed on mobile devices to documents that can be displayed on computers or on web browsers. Electronic forms can also be secured from access by people other than their intended recipients using document security systems. It would be desirable to increase the efficiency of creating and filling out paper or electronic forms.

### SUMMARY

A system may include: a blank universal form management datastore and a verified universal form management datastore; a blank universal form management engine coupled to the blank universal form management datastore; a verified universal form management engine coupled to the verified universal form management datastore and to the blank universal form management engine. In operation: the blank universal form management engine retrieves a particular blank universal form based on a universal form template, the particular blank universal form having a universal form identifier, and the particular blank universal form created by a universal form creator; the blank universal form management engine provides the particular blank universal form to a universal form filler; the verified universal form management engine receives a verified form from the universal form filler, the verified form corresponding to the particular blank universal form; the verified universal form management engine provides the verified form to the universal form creator.

In a specific implementation, the system may comprise a universal form identifier management datastore and a universal form identifier management engine coupled to the universal form identifier management datastore and the blank universal form management engine. In operation the universal form identifier management engine: retrieves the universal form identifier from the universal form identifier management datastore; embeds the universal form identifier in the particular blank universal form.

In a specific implementation, the universal form identifier comprises an image that represents the universal form identifier. In a specific implementation, the image comprises a Quick Response (QR) code that provides the contents of the particular blank universal form.

In a specific implementation, the system may further comprise a universal form filler profile management datastore and a universal form filler profile management engine coupled to the universal form filler profile management datastore and to the blank universal form management engine. In operation, the universal form filler profile management engine: selects a set of subscribers for the particular blank universal form, the set of subscribers including the universal form filler; instructs the blank universal form management engine to customize at least a portion of the particular blank universal form for the set of subscribers.

In a specific implementation, the verified form comprises automatically populated information provided by the universal form filler. In a specific implementation, the automatically populated information comprises information associated with the universal form filler and maintained in a universal form filler account.

In a specific implementation, the verified form comprises a verification field completed by the universal form filler. The verification field may comprise automatically populated information provided by the universal form filler.

A method may include: retrieving a particular blank universal form based on a universal form template, the particular blank universal form having a universal form identifier, and the particular blank universal form created by a universal form creator; providing the particular blank universal form to a universal form filler; receiving a verified form from the universal form filler, the verified form corresponding to the particular blank universal form; providing the verified form to the universal form creator.

In a specific implementation, the method may include: retrieving the universal form identifier form a universal form identifier datastore; embedding the universal form identifier in the particular blank universal form.

In a specific implementation, the universal form identifier comprises an image that represents the universal form identifier. In a specific implementation, the image comprises a Quick Response (QR) code that provides the contents of the particular blank universal form.

The method may further comprise: selecting a set of subscribers for the particular blank universal form, the set of subscribers including the universal form filler; providing an instruction to customize at least a portion of the particular blank universal form for the set of subscribers.

In a specific implementation, the verified form comprises automatically populated information provided by the universal form filler. In a specific implementation, the automatically populated information comprises information associated with the universal form filler and maintained in a universal form filler account.

In a specific implementation, the verified form comprises a verification field completed by the universal form filler. In a specific implementation, the verification field comprises automatically populated information provided by the universal form filler.

A system may include: means for retrieving a particular blank universal form based on a universal form template, the particular blank universal form having a universal form identifier, and the particular blank universal form created by a universal form creator; means for providing the particular blank universal form to a universal form filler; means for receiving a verified form from the universal form filler, the verified form corresponding to the particular blank universal form; means for providing the verified form to the universal form creator.

### BRIEF DESCRIPTION OF THE DRAWINGS

FIG. 1 depicts a diagram of an example of a universal form creation and distribution environment.

FIG. 2 depicts a flow diagram of an example of a method for universal form creation and distribution.

FIG. 3 depicts a diagram of an example of a universal form distribution engine.

FIG. 4 depicts a flow diagram of an example of a method for universal form distribution.

FIG. 5 depicts a diagram of an example of a universal form creation engine.

FIG. 6 depicts a flow diagram of an example of a method for universal form creation.

FIG. 7 depicts a diagram of an example of a universal form filler engine.

FIG. 8 depicts a flow diagram of an example of a method for universal form filling.

FIG. 9 depicts a diagram of an example of a digital device that can be specially purposed with engines and/or datastores described in this paper.

FIG. 10 depicts an example of a screen of a system incorporating a universal form creation engine.

FIG. 11 depicts an example of a screen of a system incorporating a universal form creation engine.

FIG. 12 depicts an example of a screen of a system incorporating a universal form creation engine.

FIG. 13 depicts an example of a screen of a system incorporating a universal form creation engine.

FIG. 14 depicts an example of a screen of a system incorporating a universal form creation engine.

FIG. 15 depicts an example of a screen of a system incorporating a universal form creation engine.

FIG. 16 depicts an example of a screen of a system incorporating a universal form creation engine.

FIG. 17 depicts an example of a screen of a system incorporating a universal form creation engine.

FIG. 18 depicts an example of a screen of a system incorporating a universal form creation engine.

FIG. 19 depicts an example of a screen of a system incorporating a universal form creation engine.

FIG. 20 depicts an example of a screen of a system incorporating a universal form creation engine.

FIG. 21 depicts an example of a screen of a system incorporating a universal form creation engine.

FIG. 22 depicts an example of a screen of a system incorporating a universal form creation engine.

FIG. 23 depicts an example of a screen of a system incorporating a universal form filler engine.

FIG. 24 depicts an example of a screen of a system incorporating a universal form filler engine.

FIG. 25 depicts an example of a screen of a system incorporating a universal form filler engine.

FIG. 26 depicts an example of a screen of a system incorporating a universal form filler engine.

FIG. 27 depicts an example of a screen of a system incorporating a universal form filler engine.

FIG. 28 depicts an example of a screen of a system incorporating a universal form filler engine.

FIG. 29 depicts an example of a screen of a system incorporating a universal form filler engine.

FIG. 30 depicts an example of a screen of a system incorporating a universal form filler engine.

FIG. 31 depicts an example of a home screen of a system incorporating a universal form filler engine.

FIG. 32 depicts an example of a profiles screen of a system incorporating a universal form filler engine:

FIG. 33 depicts an example of a profile edit screen of a system incorporating a universal form filler engine.

FIG. 34 depicts an example of a settings screen of a system incorporating a universal form filler engine.

FIG. 35 depicts an example of a flow diagram of a method for universal form creation and distribution.

FIG. 36 depicts an example of a flow diagram of a method for universal form creation and distribution.

FIG. 37 depicts an example of a flow diagram of a method for universal form creation and distribution.

FIG. 38 depicts an example of a flow diagram of a method for generating a universal form identifier.

FIG. 39 depicts an example of a flow diagram of a method for generating a universal form identifier.

FIG. 40 depicts an example of a flow diagram of a method for universal form creation and distribution.

### DETAILED DESCRIPTION

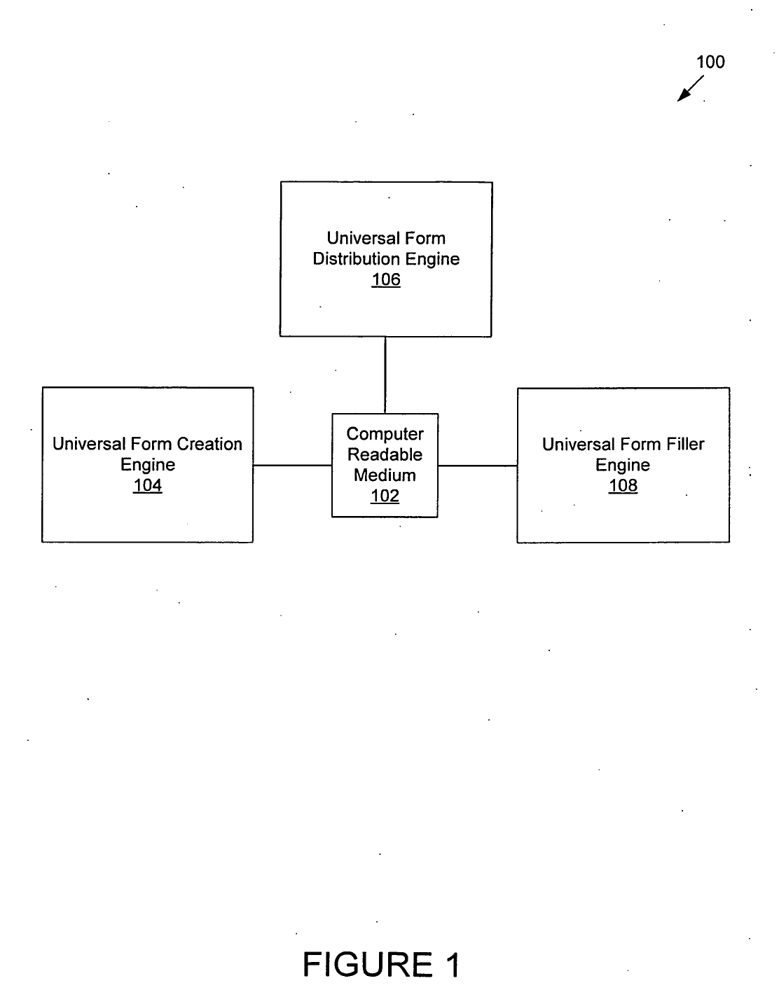

FIG. 1 depicts a diagram 100 of an example of a universal form environment. The diagram 100 includes a computer readable medium 102, a universal form creation engine 104 coupled to the computer readable medium 102, a universal form distribution engine 106 coupled to the computer readable medium 102, and a universal form filler engine 108 coupled to the computer readable medium 102. The example of FIG. 1 is intended to illustrate a universal system of form creation, distribution, and filling. As used in this paper, the word “universal” signifies a closed system of form creation, distribution, and filling, where forms created by form creators on one end of the closed system are actively or passively distributed to form fillers on another end of the closed system. A “universal form,” as used herein, is a form that is identifiable as part of the universal form creation and distribution environment. In a typical form creation, distribution, and filling flow, a universal form is typically initially “blank,” meaning none of the fields of the universal form are filled out, or “pre-populated,” which means one or more fields of the universal form are filled out. When a universal form is filled out, the form can be referred to as “populated” even if some fields are left blank. When a universal form is “verified,” the universal form has been finalized and the identity of the filler has been validated.

In a specific implementation, the computer readable medium 102 can include a networked system that includes several computer systems coupled together, such as the Internet, or a device for coupling components of a single computer, such as a bus. The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the web and is coupled to the Internet. The physical connections of the Internet and the protocols and communication procedures of the Internet and the web are well known to those of skill in the relevant art. For illustrative purposes, it is assumed the computer readable medium 102 broadly includes, as understood from relevant context, anything from a minimalist coupling of the components illustrated in the example of FIG. 1, to every component of the Internet and networks coupled to the Internet.

In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. The memory can include, by way of example but not limitation, random access memory (RAM), such as dynamic RAM (DRAM) and static RAM (SRAM). The memory can be local, remote, or distributed. The term “computer-readable storage medium” is intended to include physical media, such as memory. The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable storage medium.” A processor is considered to be “configured to execute a program” when at least one value associated with the program is stored in a register readable by the processor, or some other applicable known or convenient hardware device.

The bus can also couple the processor to an interface. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device.

In one example of operation, the computer system can be controlled by operating system software that includes a file management system, such as a disk operating system. File management systems are typically stored in non-volatile storage and cause the processor to execute the various acts required by the operating system to input and output data and to store data in the memory, including storing files on the non-volatile storage. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. Another example of operating system software with associated file management system software is VM (or VM/CMS), which refers to a family of IBM virtual machine operating systems used on IBM mainframes System/370, System/390, zSeries, System z, and compatible systems, including the Hercules emulator for personal computers.

Some portions of this paper can be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Referring once again to the example of FIG. 1, the universal form creation engine 104 is coupled to the computer readable medium 102. An “engine,” as used in this paper, includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. The term engine can refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term engine can include memory (shared, dedicated, or group) that stores code executed by the processor. The term code, as used above, can include software, firmware, and/or microcode, and can refer to programs, routines, functions, classes, and/or objects. The term shared, as used above, means that some or all code from multiple engines can be executed using a single (shared) processor. In addition, some or all code from multiple engines can be stored by a single (shared) memory. The term “group,” as used above, means that some or all code from a single engine can be executed using a group of processors or a group of execution engines. For example, multiple cores and/or multiple threads of a processor can be considered to be execution engines. In various implementations, execution engines can be grouped across a processor, across multiple processors, and across processors in multiple locations, such as multiple servers in a parallel processing arrangement.

In a specific implementation, the universal form creation engine 104 includes one or more “datastores.” A “datastore,” as used in this paper, can be implemented, for example, as software embodied in a physical computer-readable medium in firmware, in hardware, in a combination thereof, or in an applicable known or convenient device or system. Datastores described in this paper are intended, if applicable, to include any organization of data, including tables, comma-separated values (CSV) files, traditional databases (e.g., SQL), or other known or convenient organizational formats. In an example of a system where the datastore is implemented as a database, a database management-system (DBMS) can be used to manage the datastore. In such a case, the DBMS can be thought of as part of the datastore, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the datastores described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

A DBMS typically includes a modeling language, data structure, database query language, and transaction mechanism. The modeling language is used to define the schema of each database in the DBMS, according to the database model, which can include a hierarchical model, network model, relational model, object model, or some other applicable known or convenient organization. An optimal structure can vary depending upon application requirements (e.g., speed, reliability, maintainability, scalability, and cost). One of the more common models in use today is the ad hoc model embedded in SQL. Data structures can include fields, records, files, objects, and any other applicable known or convenient structures for storing data. A database query language can enable users to query databases, and can include report writers and security mechanisms to prevent unauthorized access. A database transaction mechanism ideally ensures data integrity, even during concurrent user accesses, with fault tolerance. DBMSs can also include a metadata repository; metadata is data that describes other data.

In a specific implementation, the universal form creation engine 104 is implemented on a desktop computer, a laptop computer, a mobile phone, a mobile phone with data capabilities (e.g., a “Smartphone”), a tablet computing device, or other digital device. Examples of desktop and laptop computers include Macintosh® computers running some version of Mac OS X and Windows® computers manufactured by an Original Equipment Manufacturer (OEM). Examples of mobile phones and tablet computing devices include Android® devices, devices running a version of iOS®, Blackberries®, and other devices.

In a specific implementation, the universal form creation engine 104 is implemented in whole or in part as a server or a set of servers configured to provide universal form creation services. As used in this paper, a “server” is a computer system configured to serve the needs of applications or other computer systems. A server may comprise a single computer system or a plurality of computer systems. The server may be at a single location or geographically dispersed throughout various locations. In various implementations, the servers may comprise a set of server resources associated with a cloud computing service provider.

In operation, a user, whether human or artificial, that uses the universal form creation engine 104 to create a universal form within a universal environment can be referred to as a universal form creator. The universal form can be created and stored as described later. In a specific implementation, an entity that controls the universal environment or a portion of the functionality provided therein provides access to the universal form creation engine 104 for the universal form creator through a network (e.g., via a server).

In the example of FIG. 1, the universal form distribution engine 106 is coupled to the universal form creation engine 104 through the computer readable medium 102. In a specific implementation, the universal form distribution engine 106 facilitates the distribution of blank or prepopulated universal forms. In a specific implementation, the universal form distribution engine 106 uses a list of subscribers that are the intended recipients of a universal form. The subscribers can be sent an electronic universal form, an electronic identifier of a universal form, or a paper universal form with an identifier (which can give a form filler an option to either access the universal form or use the paper universal form as a paper form). In a specific implementation, the universal form distribution engine 106 can distribute to potential subscribers if an appropriate channel is known (e.g., an email address is available, a universal form can be provided to an agent of the potential subscriber, etc.). In a specific implementation, the universal form distribution engine 106 can make a universal form available to any applicable potential subscriber (e.g., by making the universal form available on a public website, create paper fliers with a universal form identifier for public distribution, etc.).

In operation, a user, whether human or artificial, that uses the universal form distribution engine 106 to distribute a universal form within a universal environment can be referred to as a universal form distributor. The universal form creator and universal form distributor may or may not be the same. In an implementation in which the universal form distributor hands out or makes available paper universal forms, the universal form distribution engine 106 can include, for example, a printer. In an implementation in which the universal form distributor sends the electronic universal forms, the universal form distribution engine 106 can include, for example, an applicable electronic data transmission engine. In an implementation in which the universal form distributor makes electronic universal forms available to the public, the universal form distribution engine 106 can be implemented as, for example, a Web server.

In a specific implementation, the universal form distribution engine 106 is implemented on a desktop computer, a laptop computer, a mobile phone, a mobile phone with data capabilities (e.g., a “Smartphone”), a tablet computing device, or other digital device. Examples of desktop and laptop computers include Macintosh® computers running some version of Mac OS X and Windows® computers manufactured by an Original Equipment Manufacturer (OEM). Examples of mobile phones and tablet computing devices include Android® devices, devices running a version of iOS®, Blackberries®, and other devices.

In a specific implementation, the universal form distribution engine 106 is implemented in whole or in part as a server or a set of servers configured to provide universal form distribution services. As used in this paper, a “server” is a computer system configured to serve the needs of applications or other computer systems. A server may comprise a single computer system or a plurality of computer systems. The server may be at a single location or geographically dispersed throughout various locations. In various implementations, the servers may comprise a set of server resources associated with a cloud computing service provider.

In the example of FIG. 1, the universal form filler engine 108 is coupled to the universal form distribution engine 106 through the computer readable medium 102. In a specific implementation, the universal form filler engine 108 enables a form filler to fill out blank or prepopulated universal forms. Advantageously, because the universal form filler engine 108 is part of the universal environment, form modules that were filled out previously for some other universal form can be auto-populated using the form fillers previous entries (or using the form filler's information even if the information was not previously entered into a universal form).

In a specific implementation, the universal form filler engine 108 is implemented on a desktop computer, a laptop computer, a mobile phone, a mobile phone with data capabilities (e.g., a “Smartphone”), a tablet computing device, or other digital device. Examples of desktop and laptop computers include Macintosh® computers running some version of Mac OS X and Windows® computers manufactured by an Original Equipment Manufacturer (OEM). Examples of mobile phones and tablet computing devices include Android® devices, devices running a version of iOS®, Blackberries®, and other devices.

In a specific implementation, the universal form filler engine 108 is implemented in whole or in part as a server or a set of servers configured to provide universal form filler services. As used in this paper, a “server” is a computer system configured to serve the needs of applications or other computer systems. A server may comprise a single computer system or a plurality of computer systems. The server may be at a single location or geographically dispersed throughout various locations. In various implementations, the servers may comprise a set of server resources associated with a cloud computing service provider.

In a specific implementation, the universal form filler engine 108 is implemented in whole or in part as an application. As used herein, a “universal form filling application” is implemented as an engine to allow a universal form filler to access and populate a set of universal forms on the universal form filler engine 108. In various implementations, the universal form filling application may include a standalone application, a portion of memory allocated to an Internet browser on the universal form filler engine 108, a mobile application, or other applications. In some embodiments, the universal form filler engine 108 may access a universal form portal maintained in the universal environment.

In a specific implementation, the universal form filler engine 108 enables a universal form filler to access one or more blank or prepopulated universal forms for which the universal form filler or a universal form third party associated with the universal form filler is an intended recipient. In a specific implementation, the universal form filler engine 108 enables the universal form filler to populate the universal form. For example, the universal form filler engine 108 may allow the universal form filler to enter textual input and/or other forms of input to populate the universal form. In some embodiments, the universal form filler engine 108 may allow the universal form filler to populate a universal form with automatically populated information. In a specific implementation, the universal form filler engine 108 enables the universal form filler to access verification information, such as an image file comprising the universal form filler's signature, an image of the universal form filler's fingerprint (or other biometric data), a pin code associated with the universal form filler, the identity of the universal form filler's digital device, or other information. In this specific implementation, a function of the universal form distribution engine 106 (or the universal form filler engine 108) is to verify the populated universal form.

As used in this paper, a universal form filler is a human or artificial user of the universal form filler engine 108. A “universal form subscriber” can refer to a universal form filler that subscribes to a universal environment system in which universal form creators can create universal forms. A universal form subscriber may also be an “intended recipient” of a universal form. The “intended recipient” of a form is a person for whom the form is particularized. The intended recipient of a form may or may not be a universal form subscriber.

In the example of FIG. 1, in operation, a universal form creator creates a blank or prepopulated form using the universal form creation engine 104. A universal form distributor distributes (or makes available) an instance of the blank or prepopulated universal form to a universal form filler using the universal form distribution engine 106. A universal form filler populates the blank or prepopulated universal form using the form filler engine 108. The populated form can be made available to a relevant party (e.g., the form creator or the entity on behalf of whom the form creator created the universal form) through a back-channel of the universal form distribution engine 106 or directly from the universal form filler engine 108.

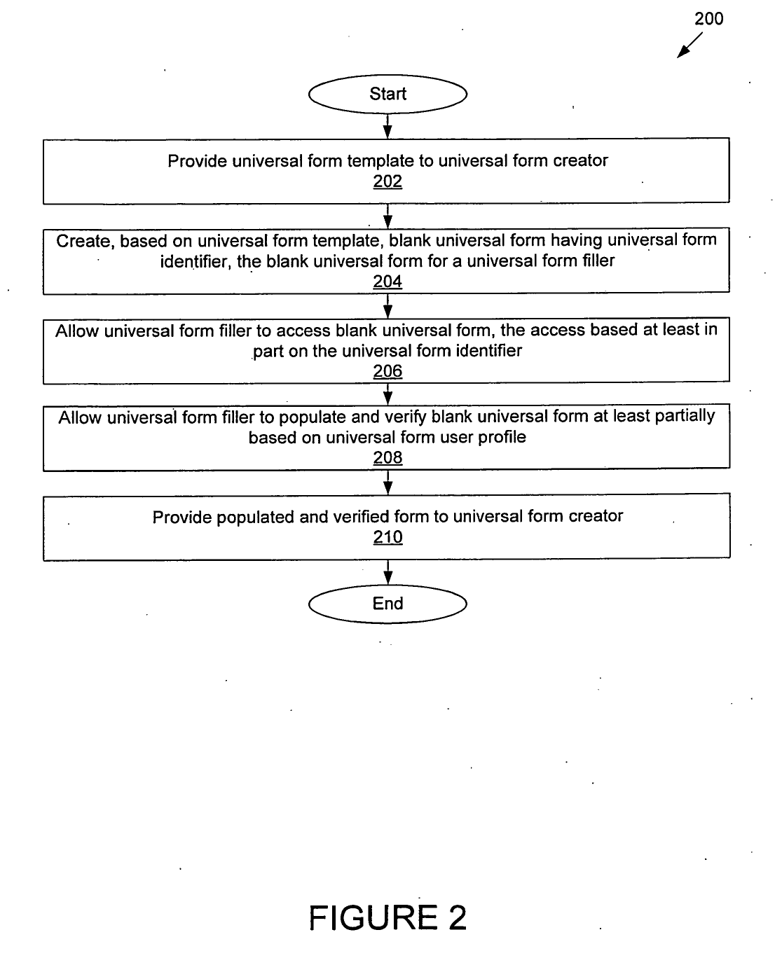

FIG. 2 depicts a flow diagram 200 of an example of a method for universal form creation and distribution. It is noted that the method, and other methods described in association with other flow diagrams in this paper, may comprise elements not shown in the example of FIG. 2 and that not all of the elements of the method are necessarily required.

In the example of FIG. 2, the flow diagram 200 starts at module 202, providing a universal form template to a universal form creator. In a specific implementation, the universal form template data structure can include a universal form module data structure. A universal form module data structure is a data structure that is identifiable within a universal environment as having an associated attribute or value that is recognized within the environment. For example, a universal form module data structure could be associated with a first name, citizenship, drivers license image, or some other attribute or value. By using universal module data structures that can be transformed as appropriate for form fillers or parties on behalf of whom form fillers populate a universal form, universal form module data structures that are incorporated into a universal form can be auto-populated by a form filler who has previously populated the universal form module (either by populating a universal form incorporating the universal form module or by populating the universal form module in advance of populating a universal form). A universal form template data structure can be a universal form blank canvas, enabling a universal form creator to build a universal form on top of it, or the universal form template data structure can include one or more universal form module data structures preconfigured. Preconfigured universal form module data structures may or may not be configurable by the universal form creator (e.g., the universal form template provider may include identifying information of the universal form template provider, the universal form creator, or some other party, or some other information, that is not customizable for a given universal form creator). In a specific implementation, universal form module data structures are provided with the universal form template to enable selection of the universal form modules for the universal form that is being created. In a specific implementation, one or more universal form module data structures are composite universal form module data structures that comprise multiple fields, such as a “name” composite universal form module data structure that can be transformed by a universal form filler to include separate fields for first name, last name, middle name, honorific, or the like.

In the example of FIG. 2, the flow diagram 200 continues to module 204, creating, based on the universal form template, a blank universal form having a universal form identifier, the blank universal form being for a universal form filler. In a specific implementation, the blank universal form is created by transforming the universal form template data structure by incorporating universal form modules at particular locations within the form. The universal form template may or may not be prepopulated as appropriate for a given implementation, configuration, or instance (e.g., with a predetermined logo) prior to transformation by a universal form creator. The universal form template may or may not be prepopulated as appropriate for a given implementation, configuration, or instance (e.g., with a teacher name for a form handed out in the teacher's class) by the universal form creator. In a specific implementation, the blank or prepopulated universal form includes a universal form identifier that uniquely identifies the universal form within the universal environment. For practical reasons, the universal form identifier can be added after the blank or prepopulated form is finalized. In a specific implementation, if the blank or prepopulated universal form is modified, a new universal form identifier can be created for it. However, it is also conceivable that the same universal form identifier could be used for later versions despite, potentially, the universal form identifier leading a universal form filler to a more recent version that is not identical to a less recent from which the universal form identifier was drawn. The blank or prepopulated universal form is for a universal form filler, though not necessarily for a universal form filler that is known (e.g., the universal form filler could access the universal form from a public forum). Alternatively or in addition, the universal form fillers that are expected to fill out the universal form could be known and the universal form could be sent directly or indirectly to the universal form fillers.

In the example of FIG. 2, the flow diagram 200 includes module 206, allowing the universal form filler to access the universal blank universal form, the access based at least in part on the universal form identifier. In a specific implementation, with specific reference to the example of FIG. 1, the universal form creation engine 104 may send or otherwise make available the blank or prepopulated universal form to the universal form distribution engine 106 via the computer readable medium 102. The universal form distribution engine 106 may send or otherwise make available the blank or prepopulated universal form to the universal form filler engine 108 via the computer readable medium 102. In some embodiments, the blank or prepopulated universal form may be emailed from the universal form creation engine 104 to the universal form distribution engine 106, and, in turn, to the universal form filler engine 108. In various embodiments, the universal form filler engine 108 may use the universal form identifier (e.g., a QR code on the blank universal form) to identify the blank universal form. For instance, a universal form filler using the universal form filler engine 108 may simply scan the QR code of the blank universal form to open an instance of the blank universal form.

In the example of FIG. 2, the flow diagram 200 includes module 208, allowing a universal form filler to populate and verify the blank universal form at least partially based on the universal form user profile. In a specific implementation, the universal form filler engine 108 may populate the blank universal form at least partially based on his or her the universal form user profile, which stores information for the universal form filler and/or universal form third parties. This may involve automatic population of the contents of the blank or prepopulated universal form. In some embodiments, the universal form filler may also verify the populated universal form or a portion thereof.

In the example of FIG. 2, the flow diagram 200 includes module 210, providing the populated and verified form to the universal form creator. In a specific implementation, the universal form filler engine 108 may directly send (e.g., directly email) the populated and verified universal form to the universal form creation engine 104. In some embodiments, the universal form filler engine 108 may instead or in addition send the populated and verified form to the universal form distribution engine 106, which in turn may send the populated and verified form to the universal form creation engine 104. It may be noted that the universal form creator is assumed for illustrative purposes to be the party that receives filled out forms; alternatively, some other party could be the completed form recipient.

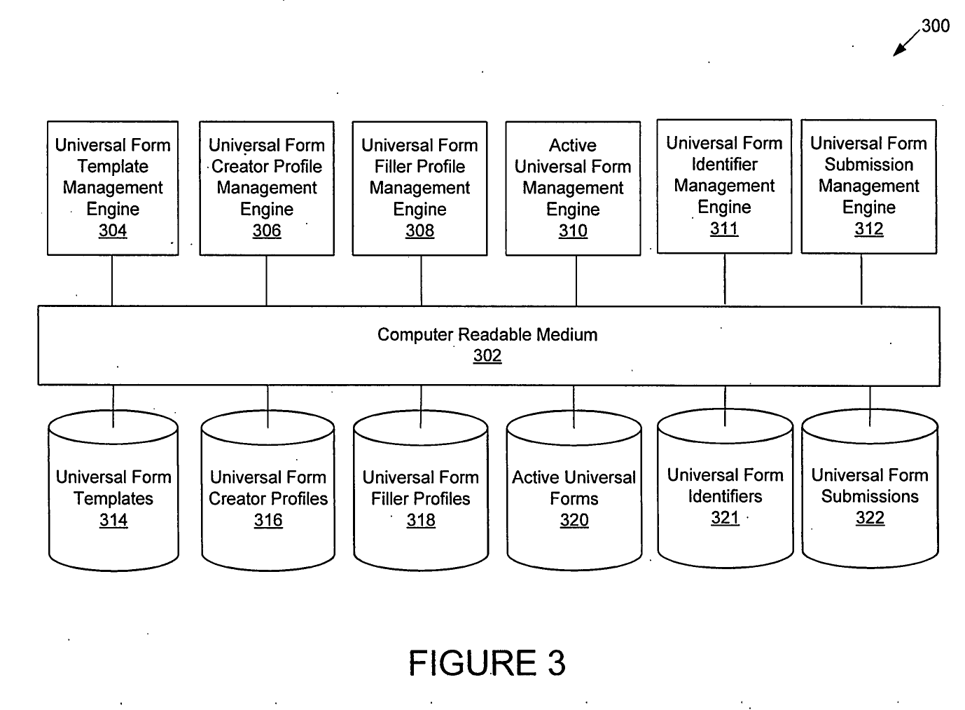

FIG. 3 depicts a diagram 300 of an example of a universal form distribution engine. In a specific implementation, the universal form distribution engine may correspond to the universal form distribution engine 102 in FIG. 1, though other capabilities associated with universal environment management are included in the example of FIG. 1. The diagram 300 includes a universal form distributor computer readable medium 302, a universal form template management engine 304 coupled to the computer readable medium 302, a universal form creator profile management engine 306 coupled to the computer readable medium 302, a universal form filler profile management engine 308 coupled to the computer readable medium 302, an active universal form management engine 310 coupled to the computer readable medium 302, a universal form identifier management engine 311 coupled to the computer readable medium 302, and a universal form submission management engine 312 coupled to the computer readable medium 302. The diagram 300 also includes a universal form templates datastore 314 coupled to the computer readable medium 302, a universal form creator profiles datastore 316 coupled to the computer readable medium 302, a universal form filler profiles datastore 318 coupled to the computer readable medium 302, an active universal forms datastore 320 coupled to the computer readable medium 302, a universal form identifiers datastore 321 coupled to the computer readable medium 302, and a universal form submissions datastore 322 coupled to the computer readable medium 302.

In the example of FIG. 3, the computer readable medium 302 is intended to represent a computer readable medium that may or may not be a part of another computer readable medium, such as the computer readable medium 102, shown in FIG. 1. Alternatively, the computer readable medium 302 can include an interface to another computer readable medium. In a specific implementation, the computer readable medium 302 includes a network interface. The computer readable medium 302 may also include an interface to a bus or communications line.

In operation, the computer readable medium 302 can transfer information to and from various engines and datastores. More specifically, the computer readable medium 302 may facilitate transmission of information between the universal form template management engine 304, the universal form creator profile management engine 306, the universal form filler profile management engine 308, the active universal form management engine 310, the universal form submission management engine 312, the universal form templates datastore 314, the universal form creator profiles datastore 316, the universal form filler profiles datastore 318, the active universal forms datastore 320, the universal form identifiers datastore 321, the universal form submissions datastore 322, and external engines and/or other computer readable media.

In a specific implementation, the universal form template management engine 304 may use portions of memory and/or a processor to query particular universal form templates in the universal form templates datastore 314. In some embodiments, the universal form template management engine 304 may receive, over the computer readable medium 302, queries to create and/or modify a particular universal form template in the universal form templates datastore 314. The queries may identify the particular universal form template using one or more template categories. In some embodiments, the queries may request all universal form templates for a given form creator, a given set of intended recipients, a given set of subscribers, or a given industry. The universal form template management engine 304 may retrieve a universal form template matching the query from the universal form templates datastore 314. Advantageously, universal form templates are data structures that can be transformed in accordance with the needs of a universal form creator to include universal form modules with universally defined attributes or values. Thus, when an instance of a universal form is being modified by a universal form filler, the universal form modules can be prepopulated with relevant data of the form filler in accordance with the universal form attributes or values definitions and/or the attributes or values can be stored in association with the universal form attributes or values definitions. Thus, for example, a form filler's first name need be entered only once, and then prepopulated when appropriate for a universal form. It may be noted that some form modules may or may not have universal form attributes or values definitions (e.g., a field, such as a field associated with a value that is only applicable within a non-universal context could be non-universal). It may further be noted that form modules that do not have universal form attributes or values definitions could later be universally defined (e.g., if the field is noticed to have been used by a quorum of form creators). In a specific implementation, the universal form template management engine 304 can treat universal forms previously created by a universal form creator as universal form templates that may or may not be available as templates to other form creators.

A universal form creation engine may or may not include an engine for management of universal form libraries for universal form creators and a universal form library datastore. A universal form library can store universal form template data structures and universal form module data structures a universal form creator can use to create a universal form data structure. A universal form library can include a set of form attribute fields for a universal form creator to use in creating a universal form. As used herein, “form attribute fields” are a set of fillable fields (e.g., via multiple-choice, drag and drop, checkboxes, money amounts, Boolean yes/no, check, text, number, text with information, and information (accept/decline)). In various implementations, form attributes may include: name, address, email, phone, gender, hair color, eye color, height, weight, right/left handedness, teacher/counselor, grade, homeroom number, student ID, and medical carrier. In a specific implementation, a universal form library can include a set of intended recipient fields for the universal form creator to use in setting intended recipients of a universal form. In various implementations, the universal form library may include one or more question fields. As used herein, “question fields” are a set of fields that a form filler can answer. In some implementations, the universal form library may include verification fields. As used herein, “verification fields” are a set of fields that can be used to verify the form for submission. Examples of verification fields include a Paypal field, a pay later field, a finger signature field, and a data based signature field. The universal form library may instead or in addition provide other fields for use in creating a universal form.

In the example of FIG. 3, the universal form creator profile management engine 306 may be coupled to the universal form creator profiles datastore 316 through the computer readable medium 302. In a specific implementation, the universal form creator profile management engine 306 may use portions of memory and/or a processor to query particular universal form creator profiles in the universal form creator profiles datastore 316. In some embodiments, the universal form creator profile management engine 306 may support, over the computer readable medium 302, queries to create and/or modify a particular universal form creator profile stored in the universal form creator profiles datastore 316. The queries may identify the particular universal form creator profile by username and/or other identifying information. In some embodiments, the queries may allow creation and/or modification of the various attributes of the particular universal form creator profile, including account access characteristics, specific universal form libraries that a particular universal form creator is allowed to access, a number of universal forms the universal form creator is allowed to generate over a specified period, a list of universal form subscribers who are allowed to receive blank universal forms generated by the universal form creator, the identities and contact information of universal form subscribers associated with the universal form creator, and other information. In some embodiments, the queries made by the universal form creator profile management engine 306 may create and/or modify access of the particular universal form creator to a universal form portal. In a specific implementation, a universal form creator can be required to include a universal form module in all universal forms created by the universal form creator (e.g., a company identifier) or a class of universal form creators, as identified from their universal form creator profile data structures.

Management of the universal form creator profile may involve managing the name/identity of an organization on behalf of which the universal form creator acts, the organization's users (e.g., universal form creators), account details (e.g., the name, email, and password of a particular form creator), payment details (e.g., Paypal account information), and a set of forms assigned to the particular organization. In a specific implementation, an organization data structure can be stored, which, as used herein, is a data structure holding information about the organization associated with the universal form creator. In a specific implementation, the universal form distribution engine maintains an account for each universal form creator with, for example, a username and a password. The account may specify a set of universal form libraries that the universal form creator is allowed to access and a number of universal forms the universal form creator is allowed to generate over a specified period, such as a month. The universal form distribution engine may further maintain a list of universal form subscribers who are allowed to receive blank universal forms generated by the universal form creator with or without limitations as identifiable in the universal form creator profiles datastore 316. For example, if the universal form creator profile allows, the universal form distribution engine can maintain a list of email addresses associated with each universal form subscriber and email an instance of a universal form to all universal form subscribers of the universal form creator. In some embodiments, the universal form distribution engine may maintain a universal form portal for access by universal form creators and universal form fillers. An example of a portal is a web portal comprising a web page for universal form creators to access a list of universal form libraries and push blank universal forms to their subscribers online.

In the example of FIG. 3, the universal form filler profile management engine 308 may be coupled to the computer readable medium 302 and to the universal form filler profiles datastore 318. In a specific implementation, the universal form filler profile management engine 308 may use portions of memory and/or a processor to query particular universal form filler profiles in the universal form filler profiles datastore 318. In some embodiments, the universal form filler profile management engine 308 may support, over the computer readable medium 302, queries to create and/or modify a particular universal form filler profile stored in the universal form filler profiles datastore 318. The queries may identify the particular universal form filler profile by username and/or other identifying information.

In some embodiments, the queries may allow creation and/or modification of the various attributes of the particular universal form filler profiles and/or universal form filling accounts. For instance, the queries by the universal form filler profile management engine 308 may allow creation and/or modification of profiles of specific intended form recipients, automatically populated information (e.g., an address of a universal form filler that is used to automatically populate the address fields of all blank universal forms that the universal form filler encounters), and of information that can be baked up, universal form filling services, such as centralized storage, email interface and management, and other services. The queries may create and/or modify a set of universal form creators and/or blank universal forms a form filler is allowed to access. In some embodiments, the queries made by the universal form filler profile management engine 308 may create and/or modify access of the particular universal form filler to the universal form portal.

In a specific implementation, a universal form filler profile management engine may manage a universal form filling account with a username and a password for each universal form filler. As used herein, a “universal form filling account” is an account associated with a universal form user that provides information about the universal form user for pre-filling universal forms. The universal form filler account may have one or more universal form user profiles. As used herein, a “universal form user profile” is a profile of a specific intended form recipient that contains information particular to the specific intended form recipient. The universal form user profile may include automatically populated information, which is information that can be used to fill fields for a particular form filler without requiring additional input by the form filler. An example of automatically populated information in this context includes an address of a universal form filler that is used to automatically populate the address fields of all blank universal forms that the universal form filler encounters. The automatically populated information may be maintained or backed up. The universal form filler account may also provide universal form filling services, such as centralized storage, email interface and management, and other services. The universal form filling account and/or profile may specify a set of universal form creators and/or blank universal forms a form filler is allowed to access.

In specific implementations, the universal form filling account may include the information of universal form third parties who are associated with the universal form filler. As used herein, a “universal form third party” is a person who is associated with a universal form filler and for whom a universal form is filled but who do not themselves fill a universal form. Examples of universal form third parties include a universal form filler's son, spouse, friend, emergency contact, other contacts, etc. As a result, the universal form filling account may maintain the information of people other than the universal form filler.

In the example of FIG. 3, the active universal form management engine 310 may be coupled to the computer readable medium 302 and the active universal forms datastore 320. In a specific implementation, the active universal form management engine 310 may use portions of memory and/or a processor to create and/or modify particular blank universal forms stored in the active universal forms datastore 320. The active universal forms may have been generated on a universal form creation engine (e.g., the universal form creation engine 104 in FIG. 1).

As used in this paper, active universal forms are universal forms that have been approved for distribution. Instances of the active universal forms are provided to at least one form filler. The manner in which instances of the active universal forms are distributed is implementation-specific, but can include some form of electronic or physical transmission of an instance of an active universal form (or an identifier thereof) to an intended form filler or making an instance of an active universal form (or an identifier thereof) available to potential form fillers. The active universal form management engine 310 can deactivate active universal forms when submission is no longer desired (e.g., after an expiration date for the form, after a threshold number of forms have been submitted, after everyone on a list has submitted a form, after a new version of the form has been created, or the like). Inactive universal forms can be stored in the universal form templates datastore 314, in an inactive universal forms datastore (not shown), or in some other applicable datastore. In a specific implementation, there is no “active” form setting; all universal forms are active unless removed from the active universal forms datastore 320.

In the example of FIG. 3, the universal form distribution engine stores the active universal forms in the active universal forms datastore 320 for distribution to subscribers and/or intended recipients. Such an implementation may or may not require a form creator send blank or prepopulated universal forms to the universal form distribution engine. In an alternative, active universal forms could be maintained by a form creator and distributed by them, with the universal form distribution engine becoming aware of the form after a first submission is received, some or all information of which could be encrypted even as to the universal form modules that are in a given universal form. Alternatively, the universal form distribution engine could inform a universal form creator that permission has been granted to access certain attributes from a datastore under the control of a third party or the form filler, thereby making it unnecessary to even pass the data through the universal form distribution engine.

The active universal forms may have been generated using a universal form library. More specifically, a universal form creation engine may access a universal form library to set form attribute fields for a particular blank universal form. The universal form creation engine may also access a universal form library to set intended recipient fields, subscriber fields, question fields, verification fields, and/or other fields. Using the universal form libraries, the universal form creation engine may allow a form creator to generate a blank universal form for subscribers and/or intended recipients. A universal form creator may or may not maintain a list of intended recipients for active universal forms. The intended recipients may or may not be represented in the universal form filler profiles datastore 318; those that are not represented may need to subscribe to a universal environment service or fill out forms without the benefit of autopopulation and/or storing entries such that they can be reused with other universal forms.

In the example of FIG. 3, the universal form identifier management engine 311 may be coupled to the universal form identifier management datastore 321 through the computer readable medium 302. In a specific implementation, the universal form identifier management engine 311 may associate universal form identifiers with blank or prepopulated universal forms. In some embodiments, the universal form identifier management engine 311 may generate the universal form identifiers for each blank or prepopulated universal form that is completed. The universal form identifier may include a visual identifier such as a QR code. The universal form identifier may include one or more of: the universal form creator's identification information, delivery methods to the universal form filler, the delivery address of the universal form filler, the desired attributes (e.g., first name, mobile phone) of the universal form filler, the universal form filler's account information, and other information.

In a specific implementation, a universal form creator may incorporate the universal form identifier on blank or prepopulated universal forms. The universal form identifier may take the form a character string and/or visual data. The universal form identifiers can be stored in the universal form identifiers datastore 321 in association with a relevant active universal form to enable a form filler to access a desired active universal form using its associated universal form identifier.

As used in this paper, a “universal form identifier” is a character string or an object that uniquely identifies a universal form within the context of the universal environment. In a specific implementation, the universal form identifier may include contents of a universal form, including an identity of the universal form creator, an identity of the subscribers and/or intended recipients, an identity of the form fields, and other information before the universal form has been populated with data by a universal form filler. In some embodiments, the universal form identifier may include visual data, including an image that represents the universal form identifier and the contents of the universal form. For instance, the universal form identifier may include a code that can be scanned by a digital device. An example of such a code can be a Quick Response (QR) code that can be scanned by an entity seeking to capture the contents of the universal form.

In the example of FIG. 3, the universal form submissions management engine 312 may be coupled to the universal form submissions management datastore 322 through the computer readable medium 302. In a specific implementation, the universal form submissions management engine 312 may use portions of memory and/or a processor to manage universal form submissions stored in the universal form submissions datastore 322. Depending upon implementation- and/or configuration-specific factors, the universal form submissions may or may not have been verified by a universal form filler.

When a form filler submits an instance of an active universal form, the universal form submission management engine 312 can store the instance in the universal form submissions datastore 322. Submission management will normally include providing the instance of the universal form or information therein to a relevant party (e.g., the universal form creator or an organization on whose behalf the universal form creator created the applicable universal form). In a specific implementation, different parties may or may not receive different information from the universal form, as opposed to providing all of the universal form data to all parties. In a specific implementation, form data that is not provided when a form is submitted can be provided later by a form filler, and the universal form submissions datastore 322 can be updated to include the updated information (or the information can be drawn from the universal form filler profiles datastore 318). Advantageously, with appropriate configurations, form data can be updated when a form filler's profile changes any time after the instance of the universal form is submitted (e.g., when the form filler moves to a new address). All organizations with appropriate permissions can have the updated form information.

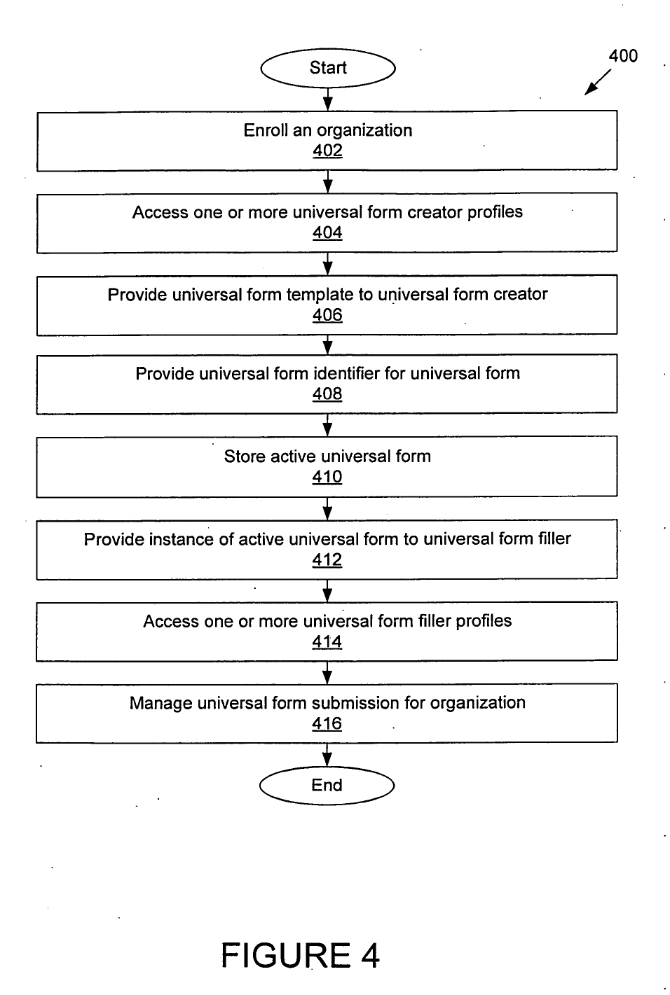

FIG. 4 depicts a flow diagram 400 of an example of a method for universal form distribution. In the example of FIG. 4, the flow diagram 400 starts at module 402, enrolling an organization. In a specific implementation, organizations that wish to create universal forms in a universal environment must first enroll with a relevant organization. It may be desirable to validate organizations to prevent unscrupulous organizations from attempting to extract information from form fillers. However, a variety of mechanisms can be employed to ensure adequate protection for form fillers, such as verification based upon universal form identifiers on universal form instances.

In the example of FIG. 4, the flow diagram 400 continues to module 404, accessing one or more universal form creator profiles. In a specific implementation, with reference to the example of FIG. 3, the universal form creator profile management engine 306 may provide instructions to access one or more form creator profiles to the universal form creator profiles datastore 316. The instructions to access the universal form creator profiles may comprise a set of queries to the universal form creator profile management datastore 316. The queries may be based on requests from a universal form creation engine (e.g., the universal form creation engine 104 in FIG. 1). Depending upon implementation- and organization-specific factors, an organization can have a number of universal form creators authorized to create universal forms on behalf of the organization. More than one universal form creator can participate in the creation of a universal form, though simultaneous participation may require the use of technology that enables the desired amount of simultaneous collaboration.

In the example of FIG. 4, the flow diagram 400 continues to module 406, providing the universal form template to the universal form creator. In a specific implementation, the universal form template includes a plurality of selectable universal form modules provided as a palette of options, one or more of which may or may not be already in the universal form template provided. The palette of options can be referred to as a universal form module palette.

In the example of FIG. 4, the flow diagram 400 continues to module 408, providing a universal form identifier for a universal form. When the universal form creator has a final version of a universal form, a universal form identifier can be created or provided and affixed to the universal form. The universal form identifier can be provided by a server to a universal form creator or a local engine could be used to generate a unique identifier for the universal form within the universal environment (e.g., by using a hash that includes a signature of the universal form creator).

In the example of FIG. 4, the flow diagram 400 continues to module 410, storing the active universal form. In a specific implementation, the active universal form management engine 310 stores the blank or prepopulated universal form in the active universal forms datastore 320 (or activates, thereby making the blank or prepopulated universal form part of the active universal forms datastore 320). In a specific implementation, the universal form identifier management engine 311 may incorporate the universal form identifier into the particular blank universal form.

In the example of FIG. 4, the flow diagram 400 continues to module 412, providing an instance of the active universal form to a universal form filler. In a specific implementation, the active universal form management engine 310 may provide the active universal form to the universal form filler.

In the example of FIG. 4, the flow diagram 400 continues to module 414, accessing one or more universal form filler profiles. In a specific implementation, the universal form filler profile management engine 308 may provide instructions to access one or more form filler profiles to the universal form filler profiles datastore 318. The instructions to access the universal form filler profiles may comprise a set of queries to the universal form filler profile management datastore 318. The queries may be based on requests from a universal form creation engine (e.g., the universal form creation engine 104 in FIG. 1) and/or a universal form filler engine (e.g., the universal form filler engine 108 in FIG. 1). The universal form filler profile may include sufficient information and permissions to enable auto-population of the active universal form, or the information and/or permissions can be received from the universal form filler.

In the example of FIG. 4, the flow diagram 400 continues to module 416, managing universal form submission for organization. In a specific implementation, the universal form submission management engine 312 may provide a filled out instance of the universal form to the organization.

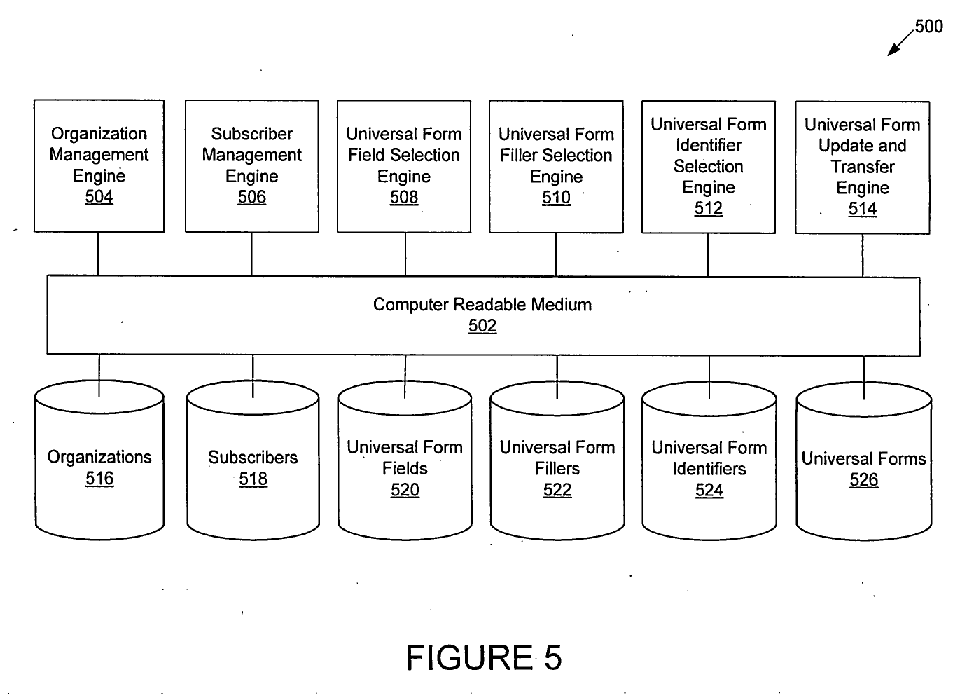

FIG. 5 depicts a diagram 500 an example of a universal form creation engine. In a specific implementation, the universal form creation engine 500 may correspond to the universal form creation engine 104 in FIG. 1. In the example of FIG. 5, the universal form creation engine includes a computer readable medium 502, an organization management engine 504 coupled to the computer readable medium 502, a subscriber management engine 506 coupled to the computer readable medium 502, a universal form field selection engine 508 coupled to the computer readable medium 502, a universal form filler selection engine 510 coupled to the computer readable medium 502, a universal form identifier selection engine 512 coupled to the computer readable medium 502, and a universal form update and transfer engine 514 coupled to the computer readable medium 502. The universal form creation engine also includes an organizations datastore 516 coupled to the computer readable medium 502a subscribers datastore 518 coupled to the computer readable medium 502, a universal form fields datastore 520 coupled to the computer readable medium 502, a universal form fillers datastore 522 coupled to the computer readable medium 502, a universal form identifiers datastore 524 coupled to the computer readable medium 502, and a universal forms datastore 526 coupled to the computer readable medium 502.

In the example of FIG. 5, the computer readable medium 502 is intended to represent a computer readable medium that may or may not be a part of another computer readable medium, such as the computer readable medium 102, shown in FIG. 1. Alternatively, the computer readable medium 502 can include an interface to another computer readable medium. In a specific implementation, the computer readable medium 502 includes a network interface. The computer readable medium 502 may also include an interface to a bus or communications line.

In operation, the computer readable medium 502 can transfer information to and from various engines and datastores. More specifically, the computer readable medium 502 may facilitate transmission of information between the organization management engine 504, the subscriber management engine 506, the universal form field selection engine 508, the universal form filler selection engine 510, universal form identifier selection engine 512, the universal form update and transfer engine 514, the organizations datastore 516, the subscribers datastore 518, the universal form fields datastore 520, the universal form fillers datastore 522, the universal form identifiers datastore 524, the universal forms datastore 526, and external engines and/or computer readable media.

In the example of FIG. 5, the organization management engine 504 may be coupled to the organization management datastore 516 through the computer readable medium 502. In a specific implementation, the organization management engine 504 may use portions of memory and/or a processor to query particular organization data structures stored in the organizations datastore 516. In some embodiments, the organization management engine 504 may create and/or modify an organization data structure in the organizations datastore 516 based on input from a universal form creator. More specifically, the organization management engine 504 may instruct the organizations datastore 516 to modify an organization data structure based on instructions from a universal form creator associated with the organization represented in the organization data structure.

In the example of FIG. 5, the subscriber management engine 506 may be coupled to the subscribers datastore 518 through the computer readable medium 502. In a specific implementation, the subscriber management engine 506 may use portions of memory and/or a processor to create and/or modify subscriber management data structures stored in the subscribers datastore 518. The subscriber management engine 506 may modify information about subscribers, including their names, contact information, and particular universal forms or classes of universal forms for which they are entitled to access.

In the example of FIG. 5, the universal form field selection engine 508 may be coupled to the universal form fields datastore 520 through the computer readable medium 502. In a specific implementation, the universal form field selection engine 508 may use portions of memory and/or a processor to create and/or modify fields for a particular blank universal form in the universal form fields datastore 520. In some embodiments, the universal form field selection engine 508 may also select a particular universal form template based on instructions from the universal form creator. The universal form field selection engine 508 may receive instructions from a universal form creator to select particular fields from a universal form library, stored on the universal form creation engine or on a universal form distribution engine (e.g., the universal form distribution engine 102 in FIG. 1). In some embodiments, the universal form field selection engine 508 may choose one or more attribute fields, one or more intended recipient fields, one or more subscriber fields, one or more question fields, one or more verification fields, and/or one or more other fields. In some implementations, the universal form field selection engine 508 may compile the selected fields into the blank universal form.

In the example of FIG. 5, the universal form filler selection engine 510 may be coupled to the universal form fillers datastore 522 through the computer readable medium 502. In a specific implementation, the universal form filler selection engine 510 may use portions of memory and/or a processor to create and/or modify a list of particular universal form fillers in the universal form fillers datastore 522; the form fillers may or may not be the intended recipients of an active universal form. The universal form filler selection engine 510 may receive instructions form a universal form creator to select particular form fillers for a universal form. In some implementations, the universal form filler selection engine 510 may compile the selected form fillers into the universal form.

In the example of FIG. 5, the universal form identifier selection engine 512 may be coupled to the universal form identifiers datastore 524 through the computer readable medium 502. The universal form identifier selection engine 512 may interface with a visual identifier assignment engine, such as a QR code implementation engine. In some embodiments, the universal form identifier selection engine 512 may be coupled to an image capture device such as a scanner or camera.

In a specific implementation, the universal form identifier selection engine 512 may use portions of memory and/or a processor to create and/or modify a universal form identifier for the particular blank universal form. In some embodiments, the universal form identifier selection engine 512 may retrieve a visual identifier, such as a QR code, to incorporate into the blank universal form. In some embodiments, the universal form identifier selection engine 512 may be configured to scan a visual identifier (e.g., a QR code) of a particular verified universal form. The universal form identifier selection engine 512 may further be configured to provide the contents of the particular verified form, as captured from the visual identifier of that form, to the universal form update and transfer engine 514 for storage in the universal forms datastore 526.

In the example of FIG. 5, the universal form update and transfer engine 514 may be coupled to the universal forms datastore 526 through the computer readable medium 502. In a specific implementation, the universal form update and transfer engine 514 may use portions of memory and/or a processor to transfer the particular blank universal form to a computer readable medium (e.g., the computer readable medium 102 in FIG. 1). In various embodiments, the universal form update and transfer engine 514 may also retrieve populated and/or verified universal forms for storage in the universal forms datastore 526. In some embodiments, the universal form update and transfer engine 514 may compile and/or finalize blank or prepopulated universal forms before they are submitted to universal form fillers.

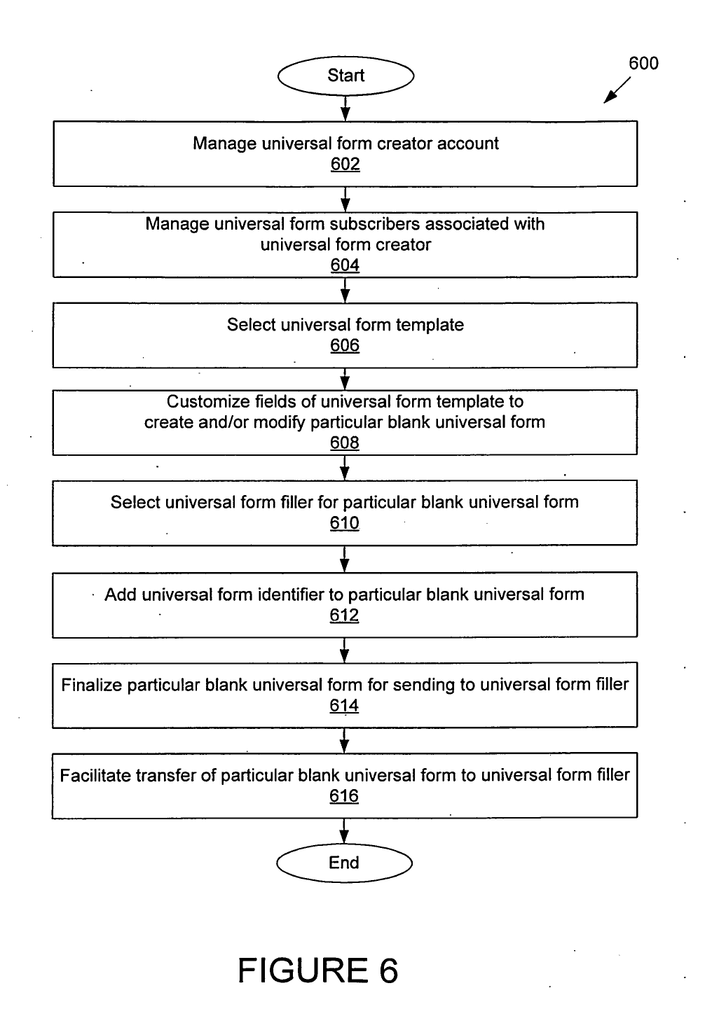

FIG. 6 depicts a flow diagram 600 of an example of a method of universal form creation. In the example of FIG. 6, the flow diagram 600 starts at module 602, managing a universal form creator account. In a specific implementation, the organization management engine 504 may manage aspects of a universal form creator account. The aspects may be stored in the organization management datastore 516.

In the example of FIG. 6, the flow diagram 600 continues to module 604, managing universal form subscribers associated with the universal form creator. In a specific implementation, the subscriber management engine 506 may manage universal form subscribers of the universal form creator. Management may involve adding new subscribers, modifying existing subscribers, and deleting existing subscribers. Management may also involve determining which universal form subscribers are allowed to access which forms or sets of forms of the universal form creator.

In the example of FIG. 6, the flow diagram 600 continues to module 606, selecting a universal form template. In a specific implementation, the universal form field selection engine 508 may select a universal form template from the universal form fields datastore 520. The selection may be based on input from the form creator.

In the example of FIG. 6, the flow diagram 600 continues to module 608, customizing fields of the universal form template to create and/or modify a blank particular form. In a specific implementation, the universal form field selection engine 508 may select particular form fields from the universal form fields datastore 520 to apply to the universal form template.

In the example of FIG. 6, the flow diagram 600 continues to module 610, selecting a universal form filler for the particular blank universal form. In a specific implementation, the universal form filler selection engine 510 may select a particular universal form filler for the particular blank universal form from the universal form fillers datastore 522. In various implementations, the particular form filler may be a subscriber of the universal form creator.

In the example of FIG. 6, the flow diagram 600 continues to module 612, adding a universal form identifier to the particular blank universal form. In a specific implementation, the universal form identifier selection engine 512 may add a universal form identifier (e.g., a visual identifier like a QR code) to the particular blank universal form. The universal form identifier selection engine 512 may transfer the blank particular form, with the embedded universal form identifier, to the universal form update and transfer engine 514.

In the example of FIG. 6, the flow diagram 600 continues to module 614, finalizing the particular blank universal form for sending to the universal form filler. In a specific implementation, the universal form update and transfer engine 514 may finalize the particular blank universal form.

In the example of FIG. 6, the flow diagram 600 continues to module 616, facilitating transfer of the particular blank universal form to the universal form filler. In a specific implementation, the universal form update and transfer engine 514 may facilitate transfer of the particular blank universal form to the universal form filler.

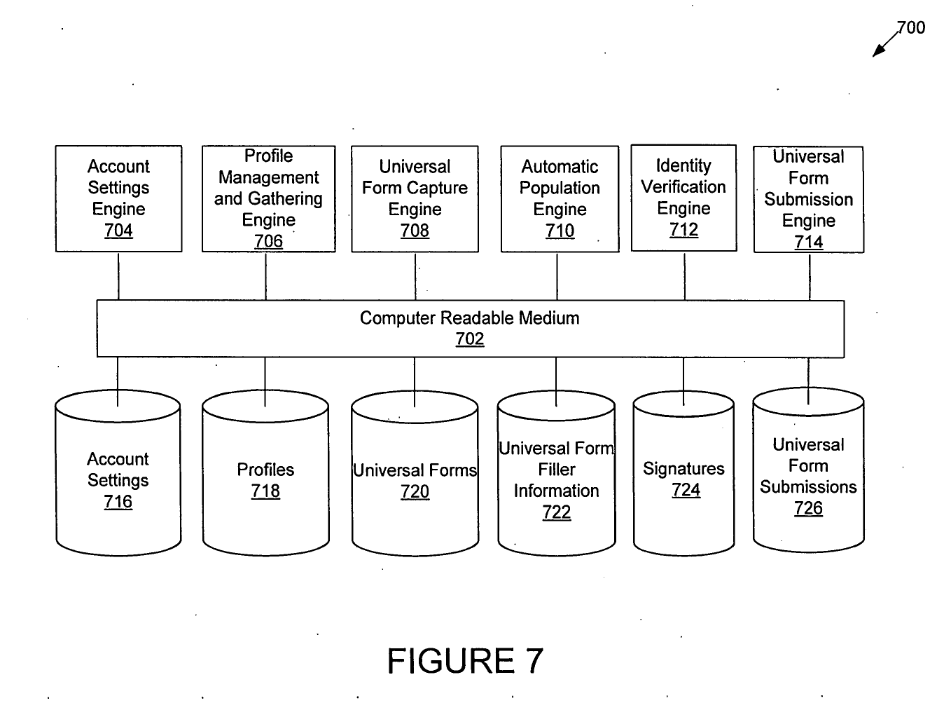

FIG. 7 depicts a diagram 700 of an example of a universal form filler engine. In a specific implementation, the universal form filler engine may correspond to the universal form filler engine 108 in FIG. 1. The diagram 700 includes a computer readable medium 702, an account settings engine 704 coupled to the computer readable medium 702, a profile management and gathering engine 706 coupled to the computer readable medium 702, a universal form capture engine 708 coupled to the computer readable medium 702, an automatic population engine 710 coupled to the computer readable medium 702, an identity verification engine 712 coupled to the computer readable medium 702, a universal form submission engine 714 coupled to the computer readable medium 702, an account settings datastore 716, a profiles datastore 718, a universal forms datastore 720, a universal form filler information datastore 722, a signatures datastore 724, and a universal form submissions datastore 726. The universal form filler engine can receive an instance of a universal form, or an identification of a universal form, for population and verification. In some implementations, the universal form filler engine may receive an electronic message that includes an instance or identifier of a universal form as an attachment. In a specific implementation, the universal form filler engine accesses and/or manages one or more universal form user profiles. In some embodiments, the universal form filler engine may allow a universal form filler to manage his or her contact information as well as universal form third parties who are affiliated with the universal form filler. Such management may involve management of contact settings (email addresses, phone numbers, addresses, etc.), financial information (Paypal accounts, credit card accounts, etc.), and particular forms for which the form filler is a subscriber or intended recipient. In some embodiments, the universal form filler engine may allow the universal form filler to manage automatically populated information. Were the blank universal form captured using the universal form identifier, the universal form filler need only capture the form (e.g., using his or her QR code reader), and may automatically populate portions of the form using the automatically populated information.

In the example of FIG. 7, the account settings engine 704 is coupled to the account settings datastore 716 through the computer readable medium 702. In a specific implementation, the account settings engine 704 may use portions of memory and/or a processor to create and/or modify a form filler's account settings, stored in a form filler account data structure in the account settings datastore 716. In various implementations, the account settings engine 704 may manage information used to login and logout of a universal form filler application. The account settings engine 704 may manage the identities of universal form fillers, contact information of universal form fillers, and financial information (e.g., Paypal or credit card account information) of universal form fillers. The account settings engine 704 may also manage other information associated with universal form fillers.

In the example of FIG. 7, the profile management and gathering engine 706 is coupled to the profiles datastore 718 through the computer readable medium 702. In a specific implementation, the profile management and gathering engine 706 may use portions of memory and/or a processor to access and/or manage universal form filler profiles. This may include accessing and/or managing the identities and other information of universal form fillers, subscribers, and/or universal form third parties associated with the universal form filler.

In the example of FIG. 7, the universal form capture engine 708 is coupled to the universal forms datastore 720 through the computer readable medium 702. In a specific implementation, the universal form capture engine 708 may use portions of memory and/or a processor to identify universal forms that have been created by a universal form creation engine (e.g., the universal form creation engine 104 in FIG. 1). In some embodiments, the universal form capture engine 708 may identify fields of a universal form and may evaluate which of those fields need to be populated to complete the universal form. In some embodiments, the universal form capture engine 708 may be configured to identify the fields of the universal form based on a visual identifier (e.g., a QR code) associated with the universal form. More specifically, in some embodiments, the universal form capture engine 708 may be configured to scan a QR code of a universal form and identify which fields of the universal form need to be populated.

In the example of FIG. 7, the automatic population engine 710 is coupled to the universal form filler information datastore 722 through the computer readable medium 702. In a specific implementation, the automatic population engine 710 may use portions of memory and/or a processor to automatically populate portions of a particular blank universal form that has been received. In some embodiments, the automatic population engine 710 may retrieve automatically populated information from the universal form filler information datastore 722. The automatically populated information may be information associated with the account or the profile of the universal form filler, universal form third parties, or others. In some embodiments, the automatically populated information is stored in its own data structure distinct from the data structures used to store account settings data and/or account profile data.

In the example of FIG. 7, the identity verification engine 712 is coupled to the identity verification datastore 724 through the computer readable medium 702. In a specific implementation, the identity verification engine 712 may use portions of memory and/or a processor to retrieve verification information from the signatures datastore 724. In various embodiments, the signatures may comprise one or more of: image file comprising the universal form filler's signature, an image of the universal form filler's fingerprint (or other biometric data), a pin code associated with the universal form filler, the identity of the universal form filler's digital device, or other information. In some embodiments, the identity verification engine 712 may append the verification information to populate a portion of the universal form.

In the example of FIG. 7, the universal form submission engine 714 is coupled to the universal form submissions datastore 726 through the computer readable medium 702. In a specific implementation, the universal form submission engine 714 may store a draft of the verified form in the universal form submissions datastore 726 if needed. The universal form submission engine 714 may also maintain an “outbox” of verified forms that are to be sent. In some embodiments, the universal form submission engine 714 may transmit the verified form to a universal form distribution engine or a universal form creation engine through the computer readable medium 702.

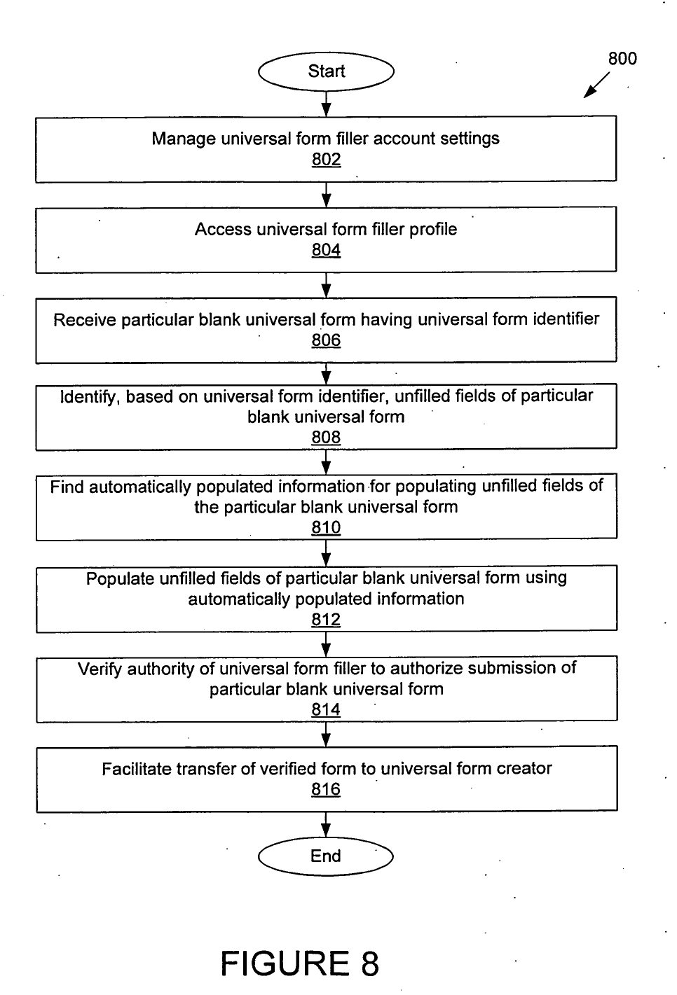

FIG. 8 depicts a flow diagram 800 of an example of a method for universal form filling. In the example of FIG. 8, the flow diagram 800 starts at module 802, managing universal form filler account settings. In a specific implementation, the account settings engine 704 may manage universal form filler account settings, including management of a universal form filler account data structure in the account settings datastore 716.

In the example of FIG. 8, the flow diagram 800 continues to module 804, accessing a universal form filler profile. In a specific implementation, the profile management and gathering engine 706 may access a universal form filler profile, stored in the profiles datastore 718.

In the example of FIG. 8, the flow diagram 800 continues to module 806, receiving a particular blank universal form having a universal form identifier. In a specific implementation, the universal form capture engine 708 may receive a particular blank universal form having a universal form identifier.

In the example of FIG. 8, the flow diagram 800 continues to module 808, identifying, based on the universal form identifier, unfilled fields of the particular blank universal form. In a specific implementation, the universal form capture engine 708 may identify, based on the universal form identifier, unfilled fields of the particular blank universal form.

In the example of FIG. 8, the flow diagram 800 continues to module 810, finding automatically populated information for populating unfilled fields of the particular blank universal form. In a specific implementation, the automatic population engine 710 may find automatically populated information for populating unfilled fields of the particular blank universal form.

In the example of FIG. 8, the flow diagram 800 continues to module 812, populating the unfilled fields of the particular blank universal form using the automatically populated information. In a specific implementation, the automatic population engine 710 may populate the unfilled fields of the particular blank universal form using the automatically populated information.

In the example of FIG. 8, the flow diagram 800 continues to module 814, verifying the authority of the universal form filler to authorize submission of the particular blank universal form. In a specific implementation, the identity verification engine 712 may verify the authority of the universal form filler to authorize submission of the particular blank universal form.

In the example of FIG. 8, the flow diagram 800 continues to module 816, facilitating transfer of the verified form to the universal form creator. In a specific implementation, the universal form submission engine 714 may facilitate transfer of the verified form to the universal form creator.

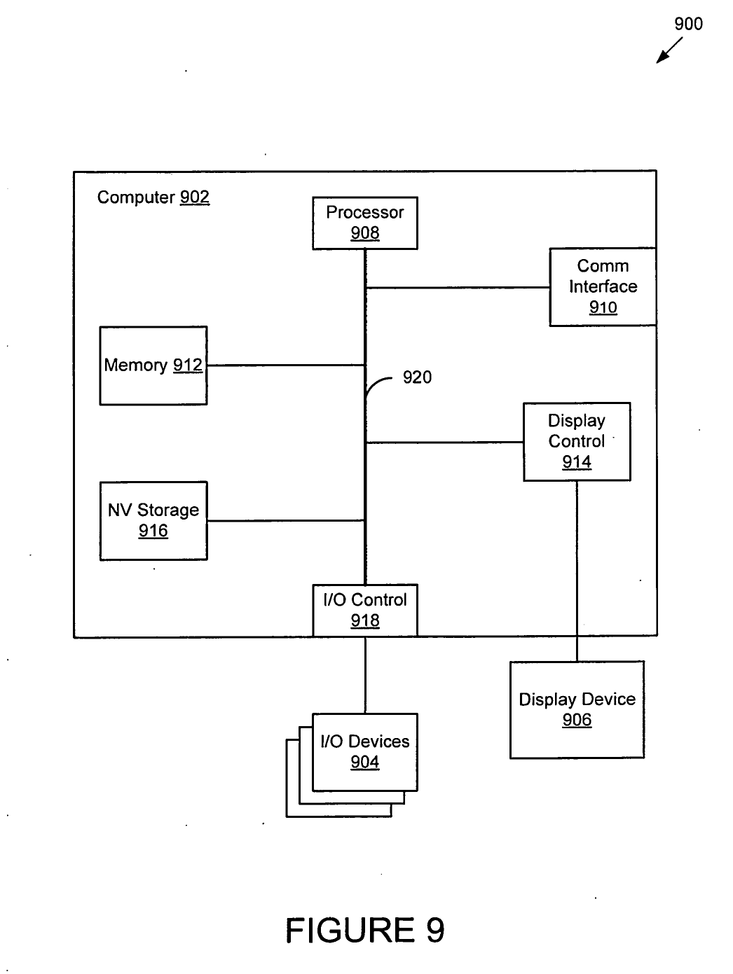

FIG. 9 shows a diagram 900 of an example of a digital device. The digital device includes a computer 902, I/O devices 904, and a display device 906. The computer 902 includes a processor 908, a communications interface 910, memory 912, display controller 914, non-volatile storage 916, and I/O controller 918. The computer 902 can be coupled to or include the I/O devices 904 and display device 906. In a specific implementation, the digital device can include a computer system that can be used as a client computer system, such as a wireless client or a workstation, or a server computer system.

In the example of FIG. 9, the computer 902 interfaces to external systems through the communications interface 910, which can include a modem or network interface. It will be appreciated that the communications interface 910 can be considered to be part of the digital device 900 or a part of the computer 902. The communications interface 910 can be an analog modem, ISDN modem, cable modem, token ring interface, satellite transmission interface (e.g. “direct PC”), or other interfaces for coupling a computer system to other computer systems.

In the example of FIG. 9, the processor 908 can be, for example, a conventional microprocessor such as an Intel Pentium microprocessor or Motorola power PC microprocessor. The memory 912 is coupled to the processor 908 by a bus 920. The memory 912 can be Dynamic Random Access Memory (DRAM) and can also include Static RAM (SRAM). The bus 920 couples the processor 908 to the memory 912, also to the non-volatile storage 916, to the display controller 914, and to the I/O controller 918.

In the example of FIG. 9, the I/O devices 904 can include a keyboard, disk drives, printers, a scanner, and other input and output devices, including a mouse or other pointing device. The display controller 914 can control in the conventional manner a display on the display device 906, which can be, for example, a cathode ray tube (CRT) or liquid crystal display (LCD). The display controller 914 and the I/O controller 918 can be implemented with conventional well known technology.

In the example of FIG. 9, the non-volatile storage 916 is often a magnetic hard disk, an optical disk, or another form of storage for large amounts of data. Some of this data is often written, by a direct memory access process, into memory 912 during execution of software in the computer 902. One of skill in the art will immediately recognize that the terms “machine-readable medium” or “computer-readable medium” includes any type of storage device that is accessible by the processor 908 and also encompasses a carrier wave that encodes a data signal.

The digital device in the example of FIG. 9 is intended to represent one of many possible computer systems which have different architectures. For example, personal computers based on an Intel microprocessor often have multiple buses, one of which can be an I/O bus for the peripherals and one that directly connects the processor 908 and the memory 912 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 912 for execution by the processor 908. A Web TV system or video game consoles which are known in the art, are also considered to be computer systems, but it can lack some of the features shown in the example of FIG. 9, such as certain input or output devices. A typical computer system will usually include at least a processor, memory, and a bus coupling the memory to the processor.

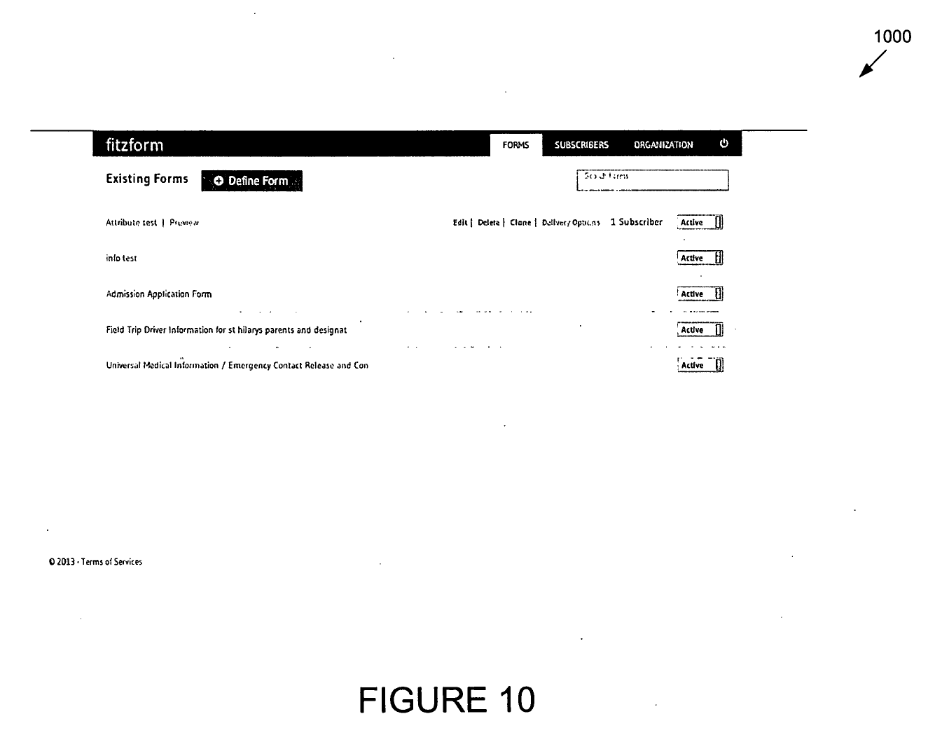

FIG. 10 depicts an example of a screen 1000 of a system incorporating a universal form creation engine. The screen 1000 may be presented to a form creator using the universal form creation engine 104, an example of which is shown in FIG. 1. The form creator using the example of FIG. 10 may be a school that is trying to create forms for students' various activities. In the example of FIG. 10, the screen 1000 may contain a “Forms” tab, a “Subscribers” tab, and an “Organization” tab, shown at the top of screen 1000.

In a specific implementation, the form creator may have selected the “Forms” tab. The “Forms” tab may allow the form creator to review a set of existing forms (designated by the tab “Existing Forms”), and to define a new form (designated by the tab “Define Form”). The form creator using the system displaying the screen 1000 has selected a set of existing forms, namely, an “Attribute test” from, an “info test” form, an “Admission Application Form,” a “Field Trip Driver Information for St. Hilarys Parents and Designated Individuals” form, and a “Universal Medical Information/Emergency Contact Release and Confirmation” form. The screen 1000 shows that all of the existing forms are in an “Active” state. The screen 1000 also shows that there are options to edit, delete, clone, and deliver the “Attribute test” form. The screen 1000 shows one subscriber of the “Attribute test” form. The screen 1000 also provides for the ability to search existing forms.

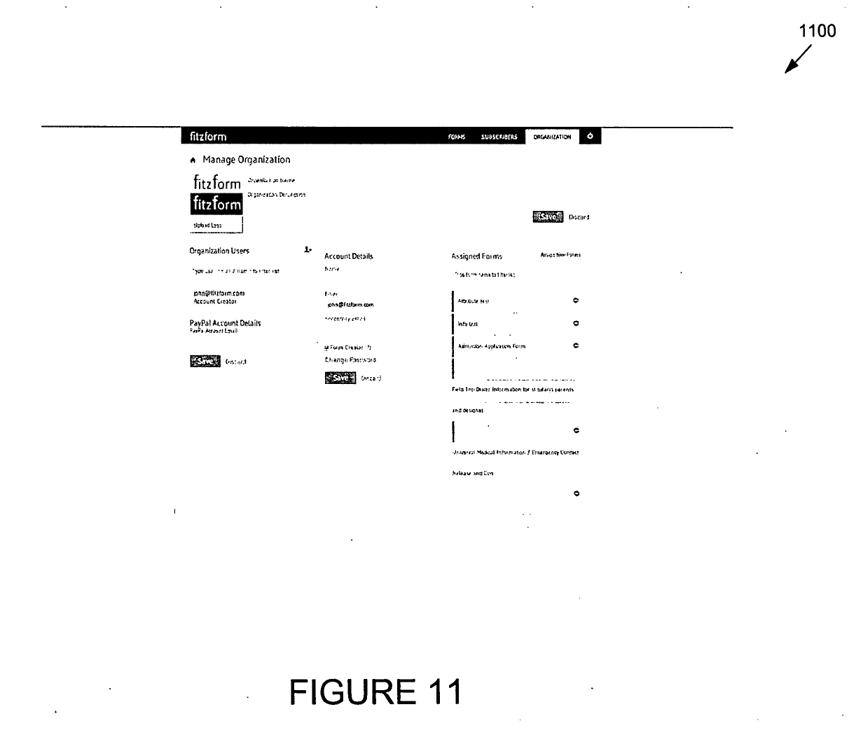

FIG. 11 depicts an example of a screen 1100 of a system incorporating a universal form creation engine. The screen 1100 may be presented to a form creator using the universal form creation engine 104, an example of which is shown in FIG. 1. In a specific implementation, the form creator may have selected the “Organization” tab, which allows the form creator to manage attributes of his or her organization that is creating the forms for subscribers. The screen 1100 shows a section allowing the form creator to manage the organization by providing the organization name and/or description.

The screen 1100 also shows a section allowing the form creator to manage the organization's users, which are particular individuals allowed to create forms for the organization. The screen 1100 displays users' emails/names, the account creator's email/name, and financial information, such as how the organization is willing to pay for form creation (here, by Paypal). The screen 1100 further shows a section to manage account details, including fields to manage the name, email, and password of a particular form creator. In the example of FIG. 11, the screen 1100 also shows a set of assigned forms which are assigned to the organization. More specifically, the screen 1100 shows that the user is assigned the following forms: “Attribute test,” “info test,” “Admission Application Form,” “Field Trip Driver Information for St. Hilarys Parents and Designated Individuals,” and “Universal Medical Information/Emergency Contact Release and Confirmation.”

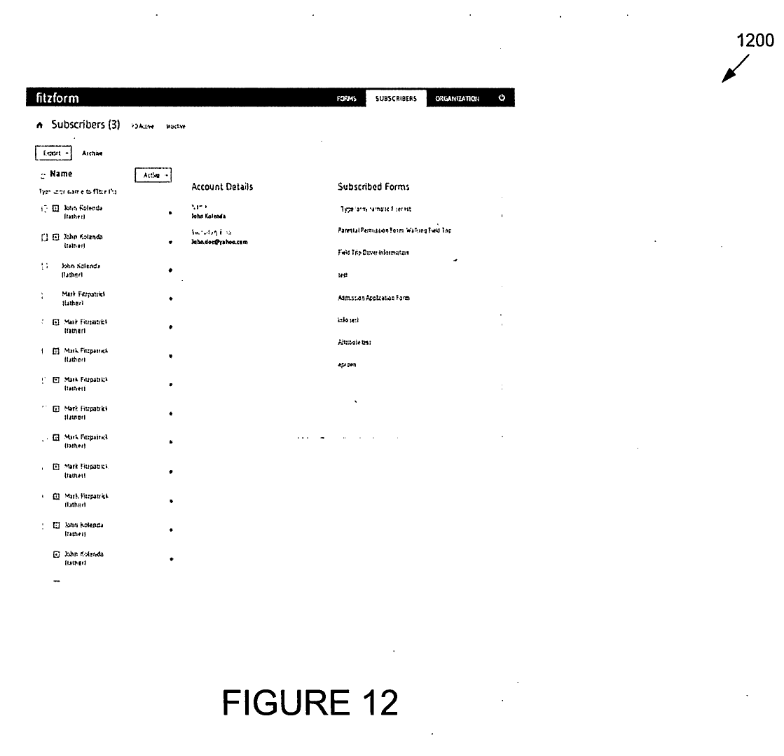

FIG. 12 depicts an example of a screen 1200 of a system incorporating a universal form creation engine. The screen 1200 may be presented to a form creator using the universal form creation engine 104, an example of which is shown in FIG. 1. In a specific implementation, the form creator may have selected the “Subscribers” tab from the screen 1000, shown in FIG. 10. In a first column of the “Subscribers” tab, the screen 1200 may have displayed a list of people who can potentially subscribe to the forms of the form creator. The screen 1200 may further display account details of subscribers in a second column, and a list of subscribed forms to which subscribers have subscribed, in a third column.

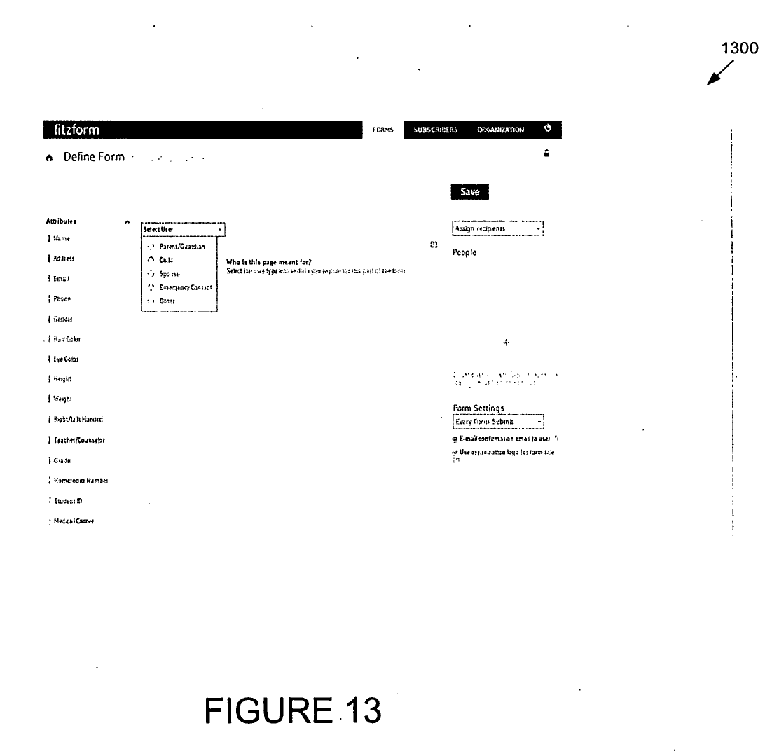

FIG. 13 depicts an example of a screen 1300 of a system incorporating a universal form creation engine. The screen 1300 may be presented to a form creator using the universal form creation engine 104, an example of which is shown in FIG. 1. In a specific implementation, the form creator may have selected the “Forms” tab from the screen 1000 in FIG. 10. The “Forms” tab may allow the form creator to define a form for a set of subscribers. Selecting the “Forms” tab may display to the form creator a set of form attribute fields. The form attributes shown in FIG. 13 include a set of blank fields that a subscriber can fill in with input (e.g., multiple-choice, drag and drop, checkboxes, money amounts, Boolean yes/no, check, text, number, text with information, and information (accept/decline)). Form attributes present in the screen 1300 include: name, address, email, phone, gender, hair color, eye color, height, weight, right/left handedness, teacher/counselor, grade, homeroom number, student ID, and medical carrier. The “Forms” tab may also include a column to select an intended recipient of the form. As shown in FIG. 13, intended recipients for the form in the screen 1300 may include: a parent/guardian, a child, a spouse, an emergency contact, or other person. The screen 1300 has a form-identification section on the right-hand side (under the word “People”) for a universal form identifier to be displayed for each form that has been defined.

The “Forms” tab may also include a column to assign recipients. As discussed, recipients may be chosen from the subscribers. The “Forms” tab may also have a section for Form Settings, which in FIG. 13 is whether email confirmations should be sent to form users and whether the organization's logo should be displayed on the form.

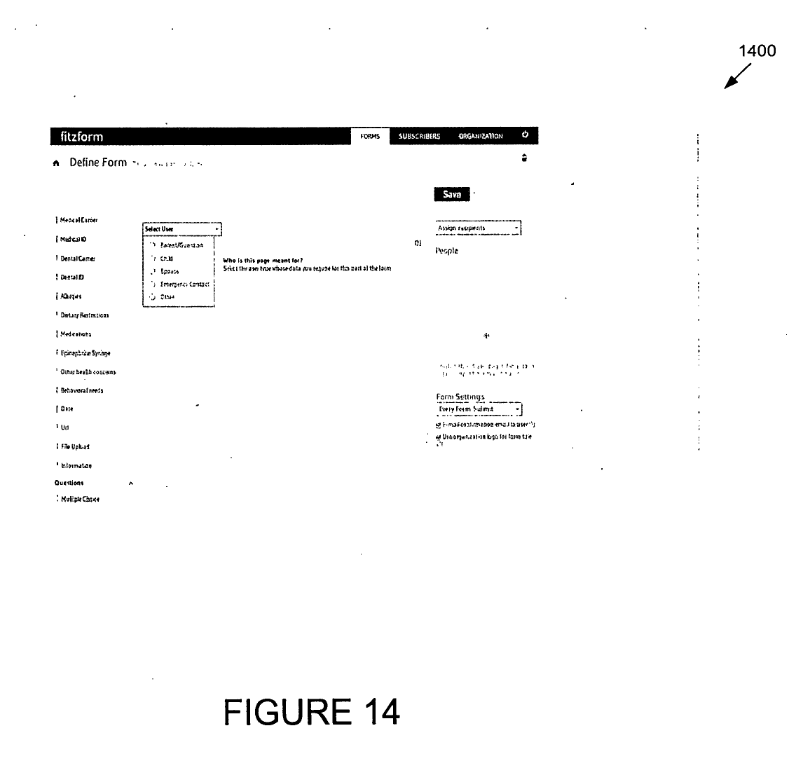

FIG. 14 depicts an example of a screen 1400 of a system incorporating a universal form creation engine. The screen 1400 is similar to the screen 1300 except that the form creator has scrolled down the page of the screen 1300 to display the screen 1400. As shown in FIG. 14, the screen 1400 includes a list of additional form attributes, including a medical ID, a dental carrier, allergies, dietary restrictions, medications, epinephrine syringes, other health concerns, behavioral needs, date, URL, file upload, and information.

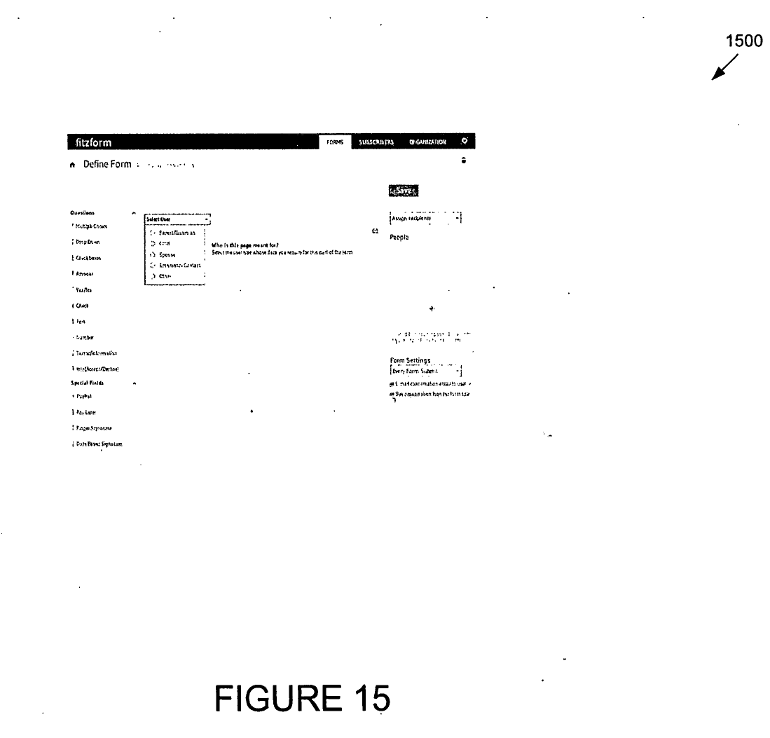

FIG. 15 depicts an example of a screen 1500 of a system incorporating a universal form creation engine. The screen 1500 is similar to the screen 1400 except that the form creator′ has scrolled down the page of the screen 1400 to display the screen 1500. As shown in FIG. 15, the screen 1500 includes a list of question fields. The screen 1500 shows that answers can be multiple-choice, drag and drop, checkboxes, money amounts, Boolean yes/no, check, text, number, text with information, and information (accept/decline). The screen 1500 also shows a list of verification fields. Examples of verification fields shown in FIG. 15 include a Paypal field, a pay later field, a finger signature field, and a data based signature field.

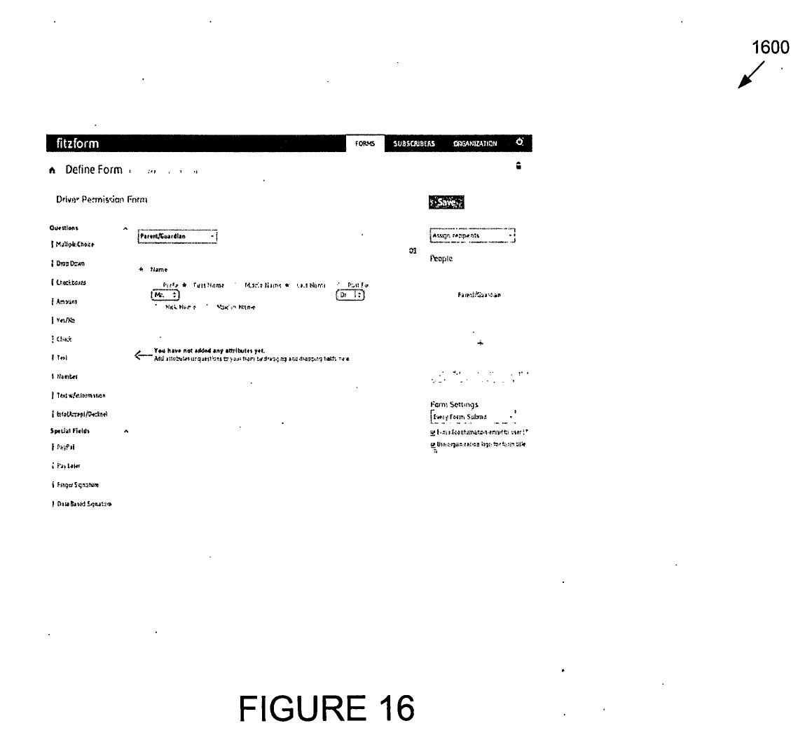

FIG. 16 depicts an example of a screen 1600 of a system incorporating a universal form creation engine. In a specific implementation, a form creator using the universal form creation engine has defined a new form, namely a “Driver Permission Form.” The form creator has selected a “Parent/Guardian” in the “Define User” field. The screen 1600 shows the system has displayed a first portion for the user of the form to enter the user's name, and a second prompt for the form creator to add new attributes to the “Driver Permission Form.” The People portion on the right-hand side has become automatically populated with a “Parent/Guardian.”

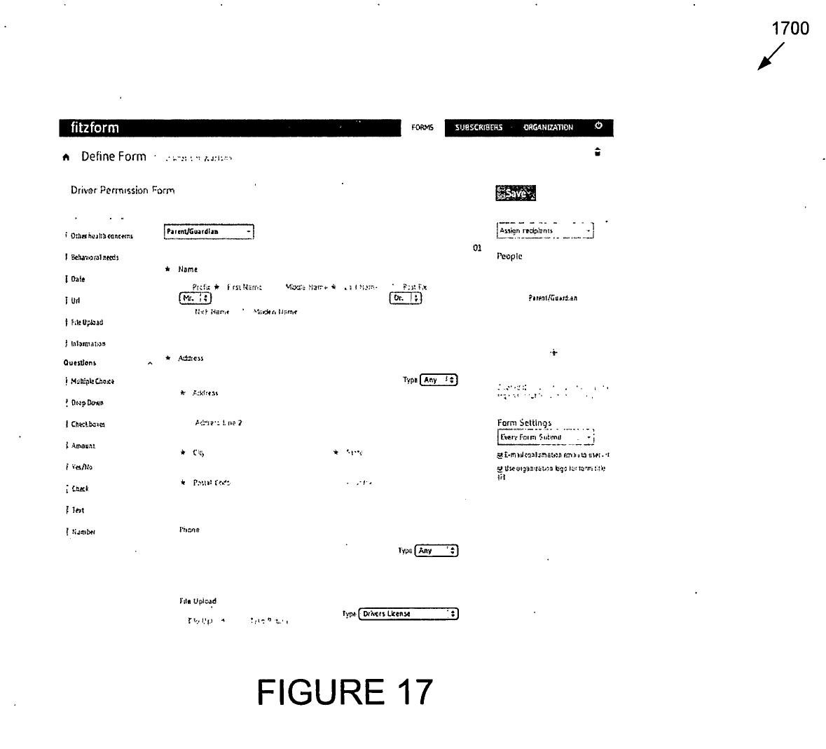

FIG. 17 depicts an example of a screen of a system incorporating a universal form creation engine. In a specific implementation, a form creator using the universal form creation engine has added attributes to the Driver Permission Form shown in FIG. 16. More specifically, the form creator has added an address attribute, a phone contact attribute, and a file upload attribute. The address attribute and the phone contact attribute may prompt the user to enter an address data structure and a ten digit number, respectively. Both the address attribute and the phone contact attribute may have a type (e.g., the address attribute may have a “residential” vs. “business” type and the phone contact information may have a cell/home/work type). The file upload attribute may have, associated with it, user-generated image input such as an image captured by the form user's digital device using a camera, scanner, or input device on the digital device.

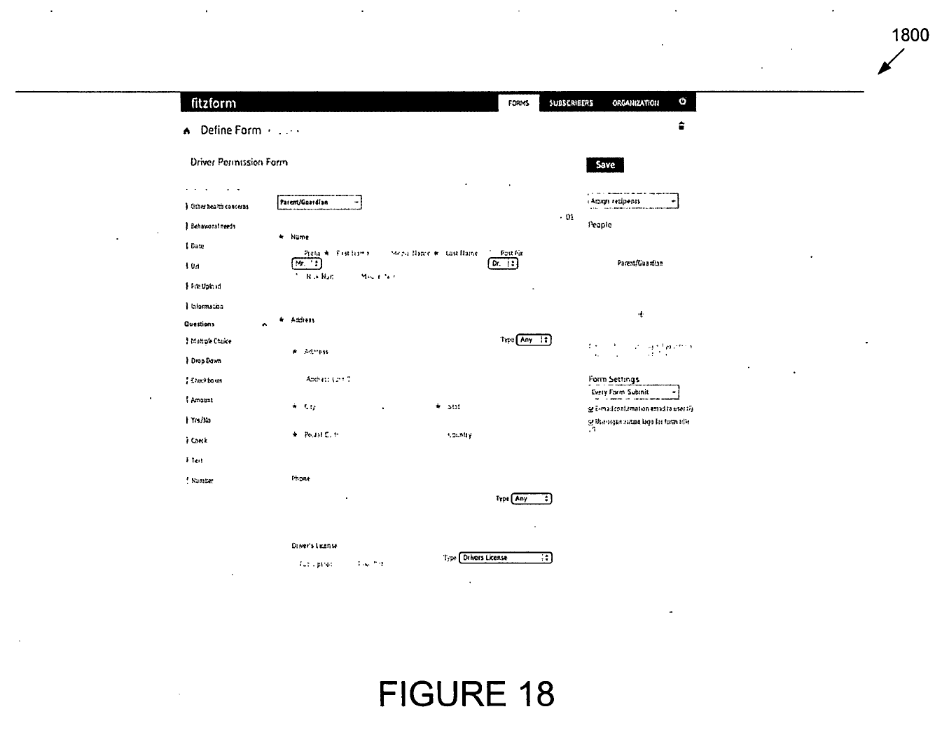

In the screen 1700, the user-generated image input may comprise a photo/scan of the parent/guardian's child's driver's license. FIG. 18 depicts another example of a screen 1800 of a system incorporating a universal form creation engine.

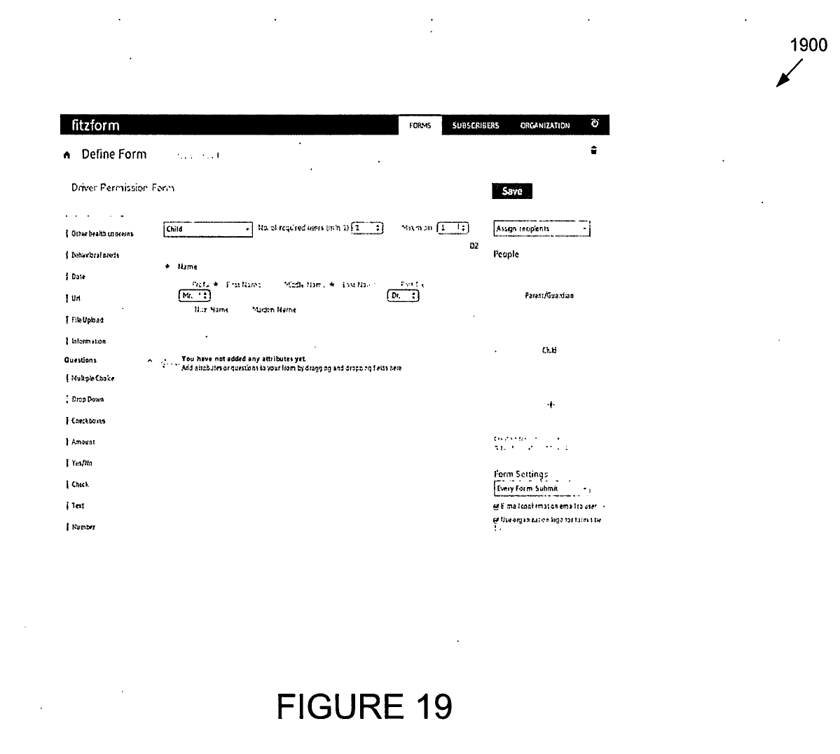

FIG. 19 depicts an example of a screen 1900 of a system incorporating a universal form creation engine. In a specific implementation, the form creator using the universal form creation engine has selected “Child” in the “Define User” field. The screen 1900 shows that the system has displayed a minimum and maximum number of required users for the form.

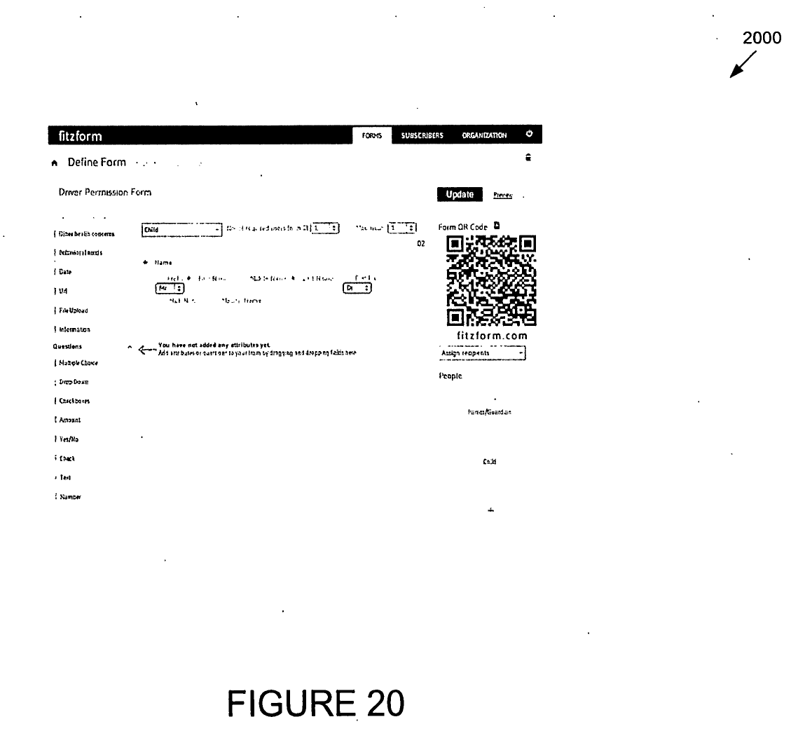

FIG. 20 depicts an example of a screen 2000 of a system incorporating a universal form creation engine. In a specific implementation, the form creator using the universal form creation engine has selected the “Save” button displayed in the screen 1900 in FIG. 19. In the example of FIG. 20, the universal form identifier for the child Driver Permissions Form has appeared in the form of a QR code on the form-identification section.

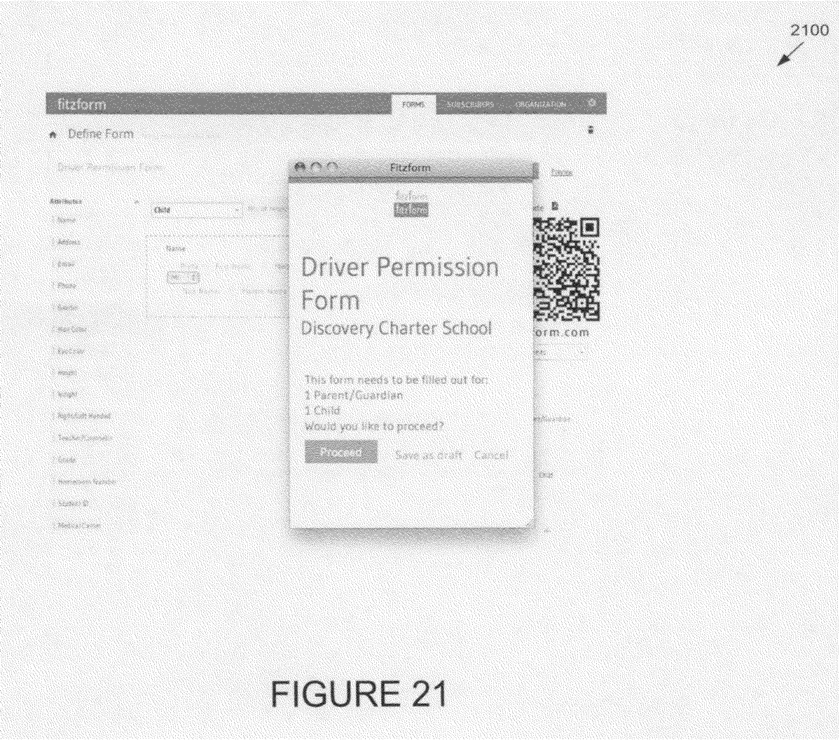

FIG. 21 depicts an example of a screen 2100 of a system incorporating a universal form creation engine. In a specific implementation, a form creator using the universal form creation engine has selected the “Preview” button displayed in the screen 2000 in FIG. 20. In the example of FIG. 21, the universal form creation engine has displayed an introductory page that shows how the first page of the form will be displayed on a computer system that includes a universal form filler engine. As shown in FIG. 21, the page lists the form title, the intended users of the form, and whether to proceed, save, or cancel.

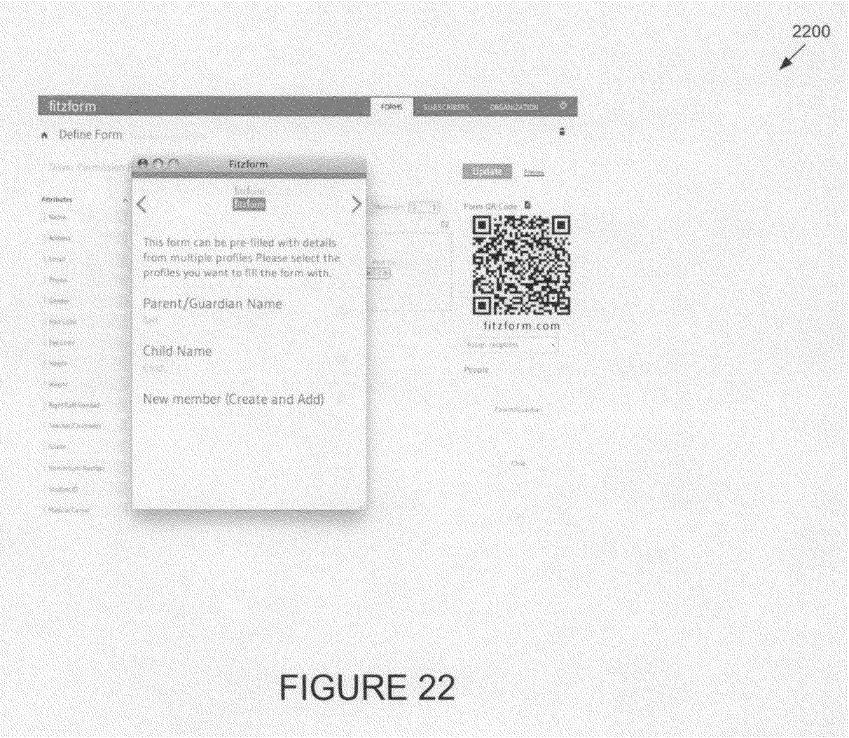

FIG. 22 depicts an example of a screen 2200 of a system incorporating a universal form creation engine. In a specific implementation, a form creator using the universal form creation engine has requested the universal form creation engine to display a request page for pre-filled information. As shown in FIG. 22, the request page may include a request to pre-fill the form using information associated with the user's universal form filling account. As discussed, a “universal form filling account” is an account associated with a universal form user that provides information about the universal form user for pre-filling universal forms.

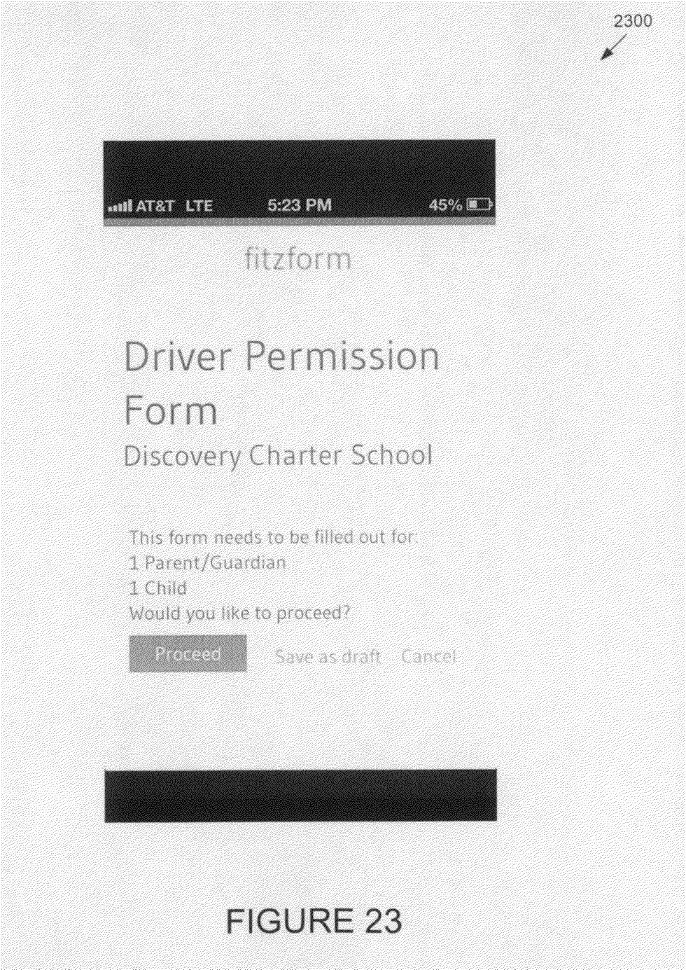

FIG. 23 depicts an example of a screen 2300 of a system incorporating a universal form filler engine. The screen 2300 may be presented to a form user using the universal form filler engine 108, an example of which is shown in FIG. 1. In a specific implementation, the form user may have viewed the screen 2300 in a mobile application. The screen 2300 may contain an introductory page. In this example, the screen 2300 contains the introductory page that a form creator previewed in the screen 2100 in FIG. 21. More specifically, the screen 2300 may contain a form title (“Driver Permission Form”), an organization title (“Discovery Charter School”), and one or more intended form recipients (“Parent/Guardian” and “Child”). The screen 2300 may also ask the form user whether the form user would like to proceed, save a draft, or cancel.

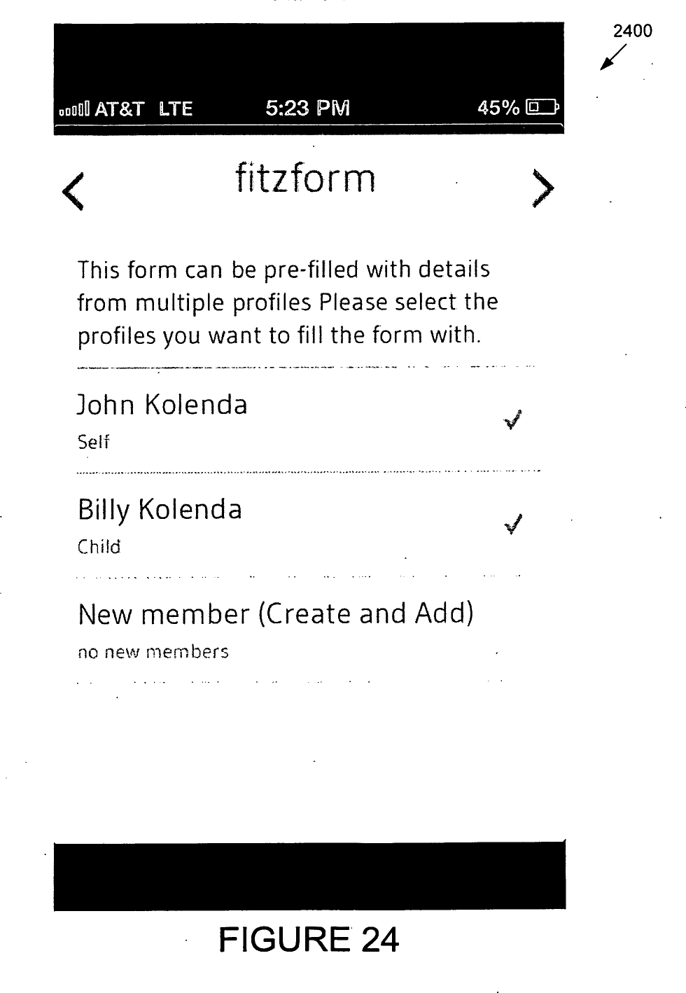

FIG. 24 depicts an example of a screen 2400 of a system incorporating a universal form filler engine. In a specific implementation, the form user may have navigated to the screen 2400 by selecting the “Proceed” button shown on the screen 2300 in FIG. 23. The screen 2400 may contain a prompt indicating that the form can be pre-filled with details from multiple universal form user profiles. The screen 2400 shows two universal form user profiles available on the digital device for the form, namely a first user named “John” and a second user named “Billy.” The screen 2400 also shows a section to add a new universal form user profile. In a specific implementation, the screen 2400 may contain navigation arrow to guide the form user through selecting intended form users and other aspects of form completion.

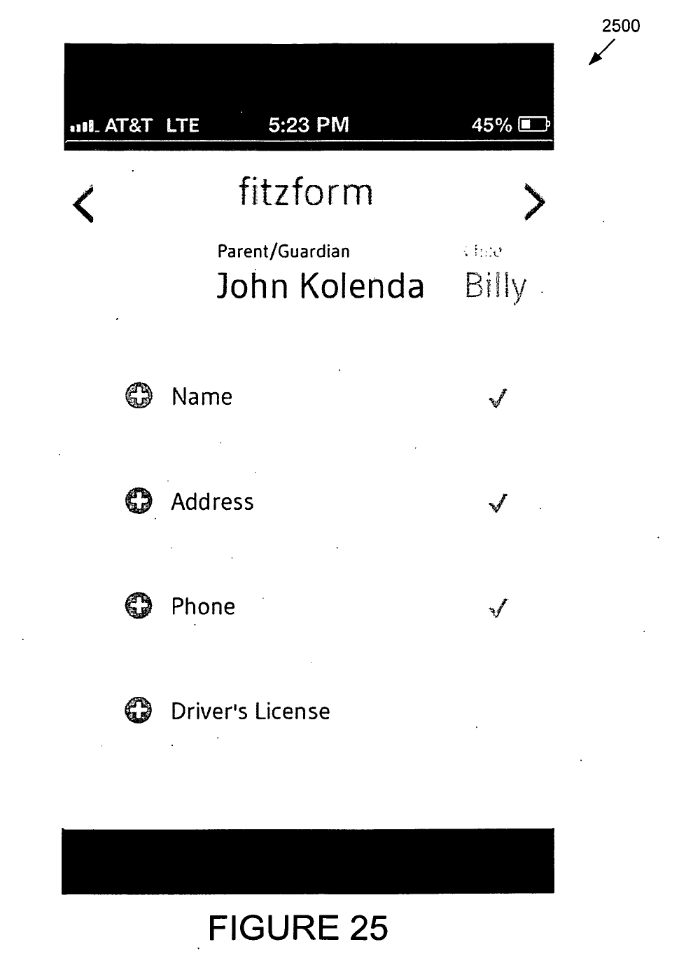

FIG. 25 depicts an example of a screen 2500 of a system incorporating a universal form filler engine. In a specific implementation, the form user may have navigated to the screen 2500 by selecting the “Proceed” button in the screen 2400. In the example of FIG. 25, the screen 2500 may show a name field, an address field, a phone field, and a driver's license field. Checkmarks next to the name field, the address field, and the phone field may indicate that pre-filled values for these fields are stored in the universal form user profile for the user “John.” The driver's license field, however, may require additional information from the form user, the additional information not being previously stored. In the example of FIG. 25, the name, address, phone, and driver's license fields are not expanded.

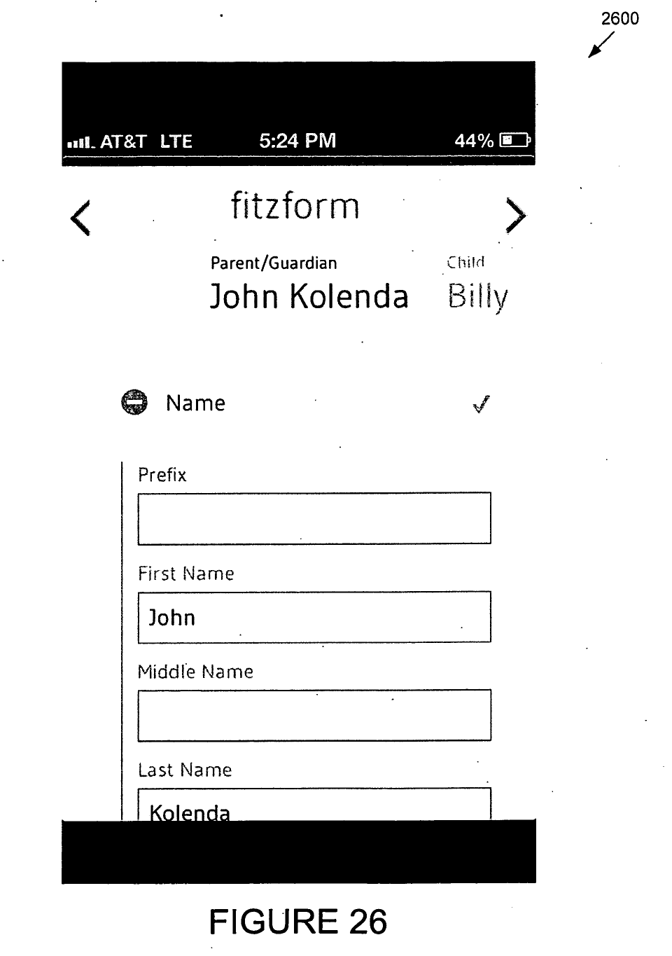

FIG. 26 depicts an example of a screen 2600 of a system incorporating a universal form filler engine. In a specific implementation, the form user may have navigated to the screen 2600 by expanding the name field in the screen 2500 of FIG. 25. In the example of FIG. 26, the screen 2600 may show an expanded name field, which includes fields for a prefix, a first name, a middle name, a last name, and so on. As shown in FIG. 26, the first name and the last name are pre-filled based on pre-filled values stored in the universal form user profile for the user “John.”

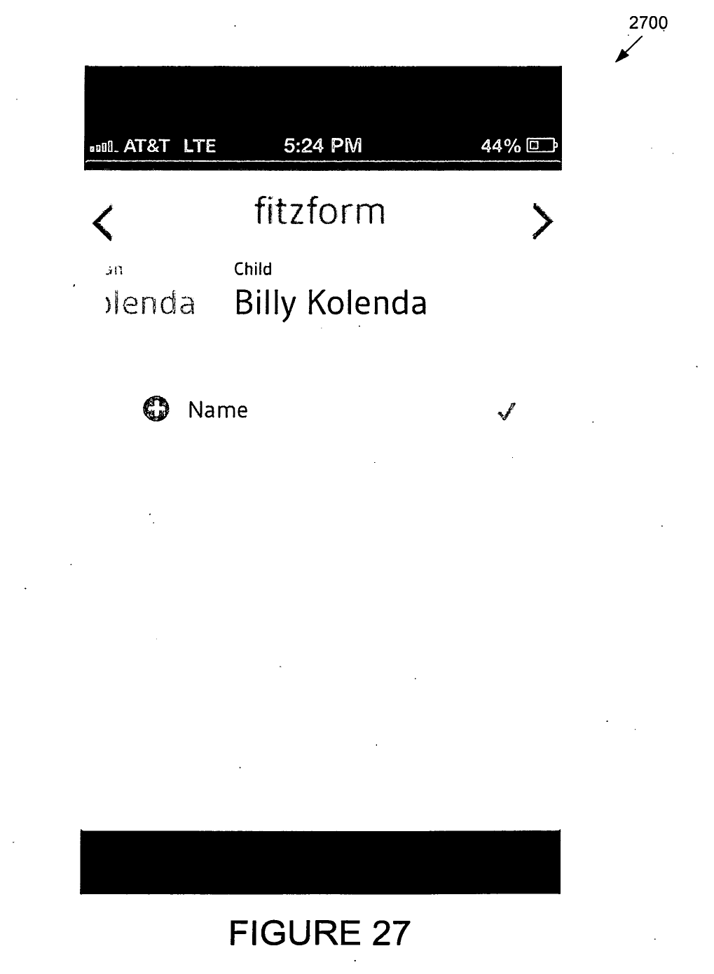

FIG. 27 depicts an example of a screen 2700 of a system incorporating a universal form filler engine. In a specific implementation, the form user may have navigated to the screen 2700 by scrolling right on the navigation arrows on the top of the screen 2600 in FIG. 26. In the example of FIG. 27, the screen 2700 may have a name field for the second intended recipient of the form, namely the child. The screen 2700 shows the name field of the child as including pre-filled information and not expanded.

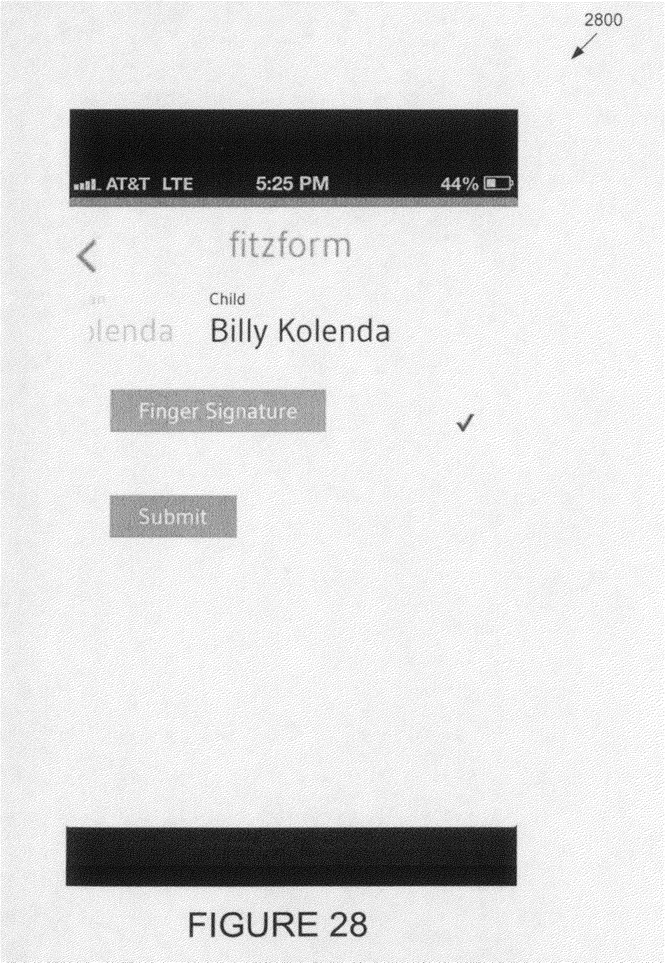

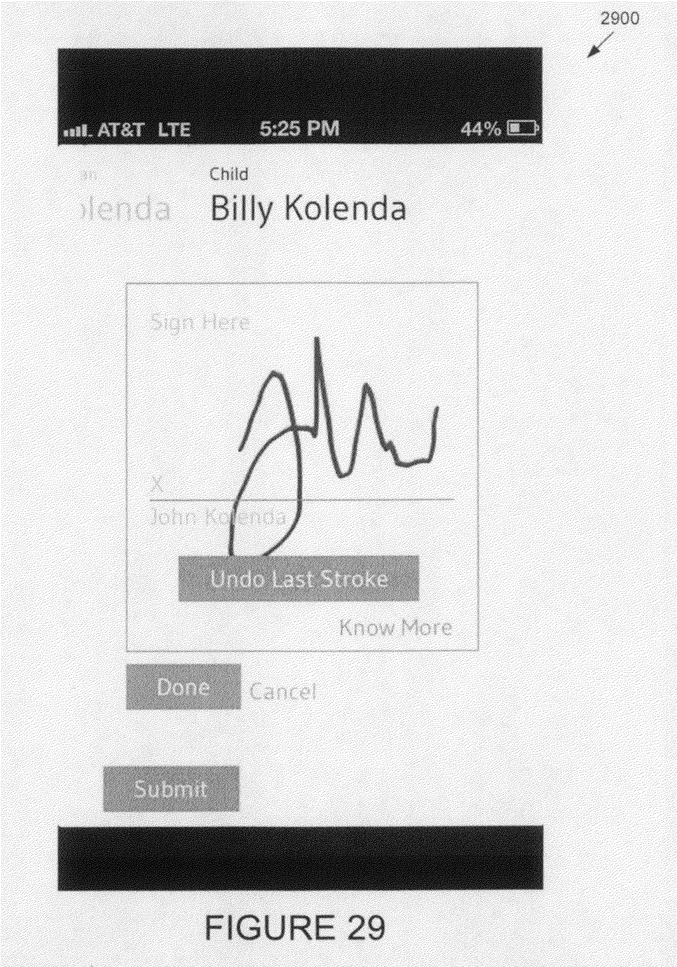

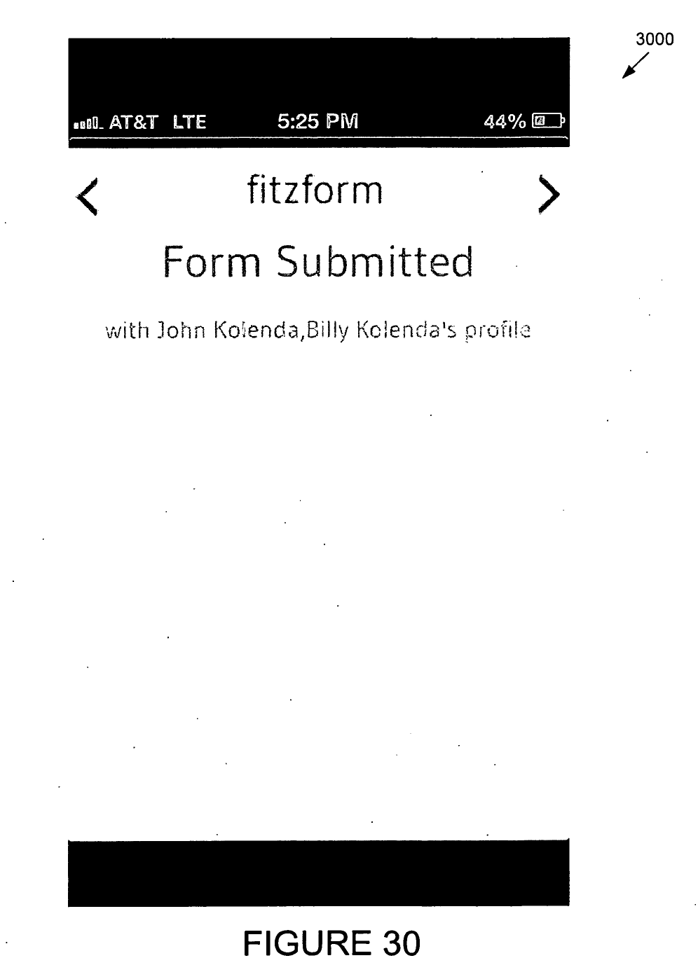

FIG. 28 depicts an example of a screen 2800 of a system incorporating a universal form filler engine. In a specific implementation, the form user may have navigated to the screen 2800 by scrolling right on the navigation arrows on the top of the screen 2700 in FIG. 27. In the example of FIG. 28, the screen 2800 shows a verification field that includes a request for a finger signature. As shown in the screen 2800, the form user has previously stored his finger signature, and as a result, an image file for the finger signature is stored as a part of the universal form user profile for “John.” In a specific implementation, selecting the “finger signature” button may display the image file for his finger signature. FIG. 29 depicts an example of a screen 2900 of a system incorporating a universal form filler engine. In a specific implementation, the form user has selected the “finger signature” button in the screen 2800 in FIG. 28 to display the image file for his finger signature. The screen 2900 may also contain a “submit” button for the form user to submit the completed form. FIG. 30 depicts an example of a screen 3000 of a system incorporating a universal form filler engine. In a specific implementation, the form user has selected the “submit” button on the bottom of the screen 2900 in FIG. 29.

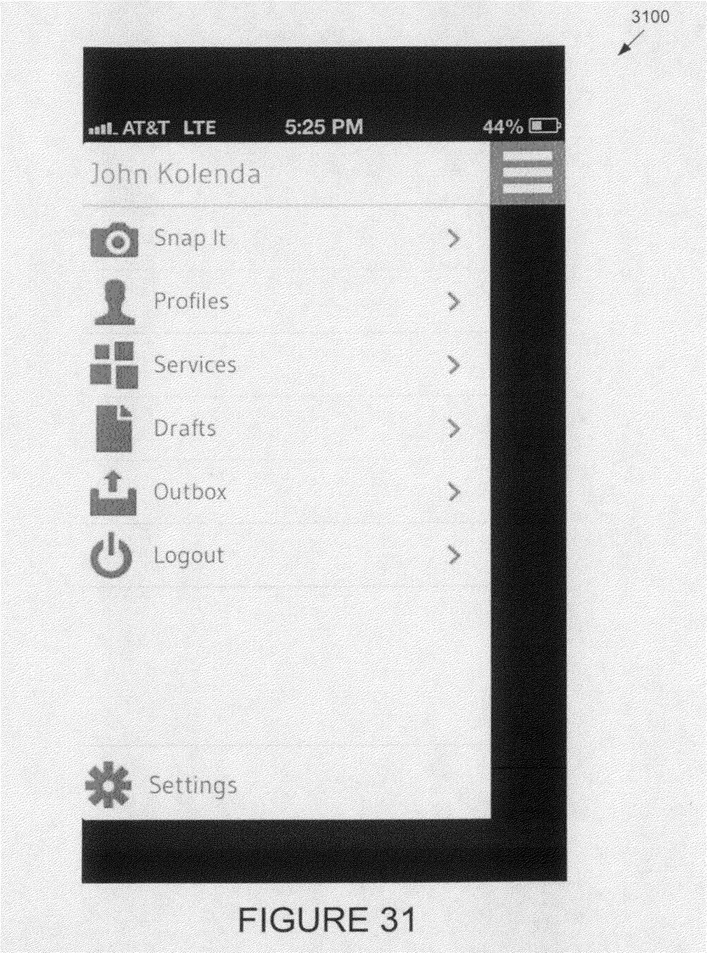

FIG. 31 depicts an example of a home screen 3100 of a system incorporating a universal form filler engine. In a specific implementation, a form user may have navigated to the home screen 3100 using a mobile application swipe gesture. In the example of FIG. 31, the home screen 3100 may contain one or more tabs, including tabs for: image capture, profile management, service access, draft form access, form outbox access, and to logout of universal form filling services. The home screen 3100 may also contain a settings tab.

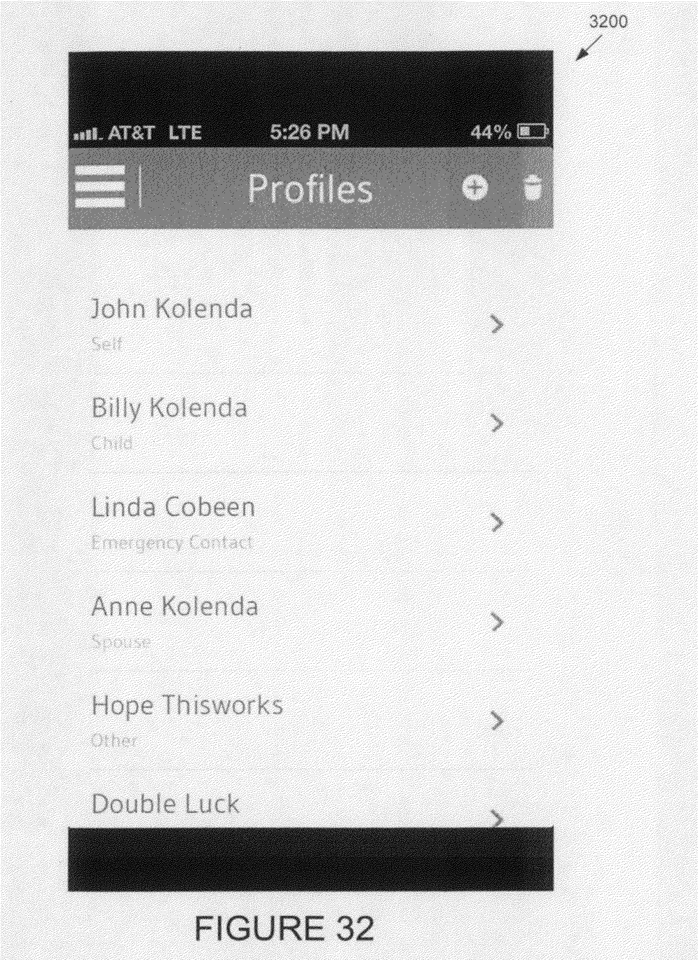

FIG. 32 depicts an example of a profiles screen 3200 of a system incorporating a universal form filler engine. In a specific implementation, the form user may have navigated to the profiles screen 3200 by selecting the profiles tab of the home screen 3100 in FIG. 31. In the example of FIG. 32, the profiles screen 3200 shows a list of universal form user profiles, including universal form user profiles for John (the application user) and universal form third parties, i.e., John's child Billy, the emergency contact Linda; John's spouse Anne, another contact Hope, and others. Selecting each of these profiles may link the form user to a profile edit screen to edit the selected profile.

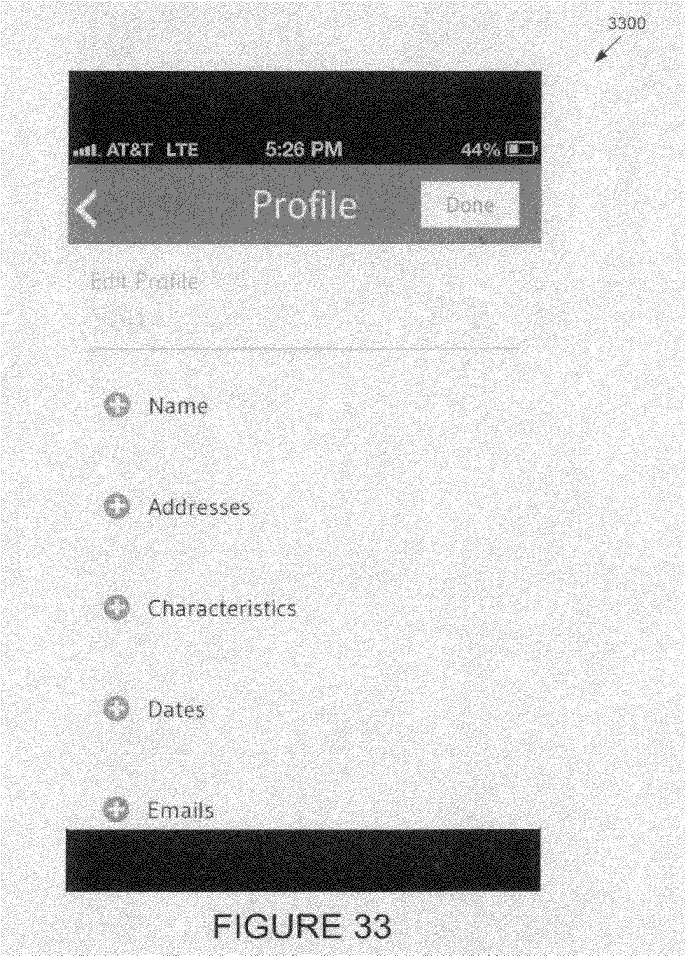

FIG. 33 depicts an example of a profile edit screen 3300 of a system incorporating a universal form filler engine. In a specific implementation, the form user may have navigated to the profiles screen 3200 by selecting the profile for the universal form user “John,” shown in the profiles screen 3200 in FIG. 32. In the example of FIG. 33, the profile edit screen 3300 may allow the form user to edit information such as: name, address, characteristics, dates, and emails.

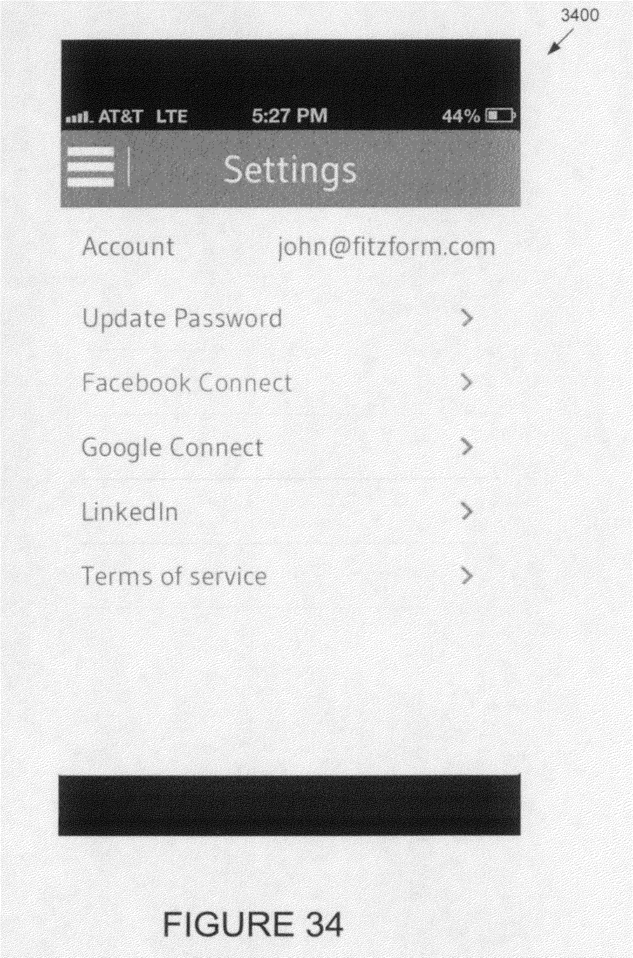

FIG. 34 depicts an example of a settings screen 3400 of a system incorporating a universal form filler engine. In a specific implementation, the form user may have navigated to the settings screen 3400 by selecting the settings tab of the home screen 3100 shown in FIG. 31. In the example of FIG. 34, the settings screen 3400 may include an account name field, an update password field, a Facebook connect field, a Google connect field, a LinkedIn connect field, and a terms of service field. The Facebook connect, Google connect, and LinkedIn connect fields may link the user to social networking accounts and may allow the user to fill fields based on information stored in social networking sites.

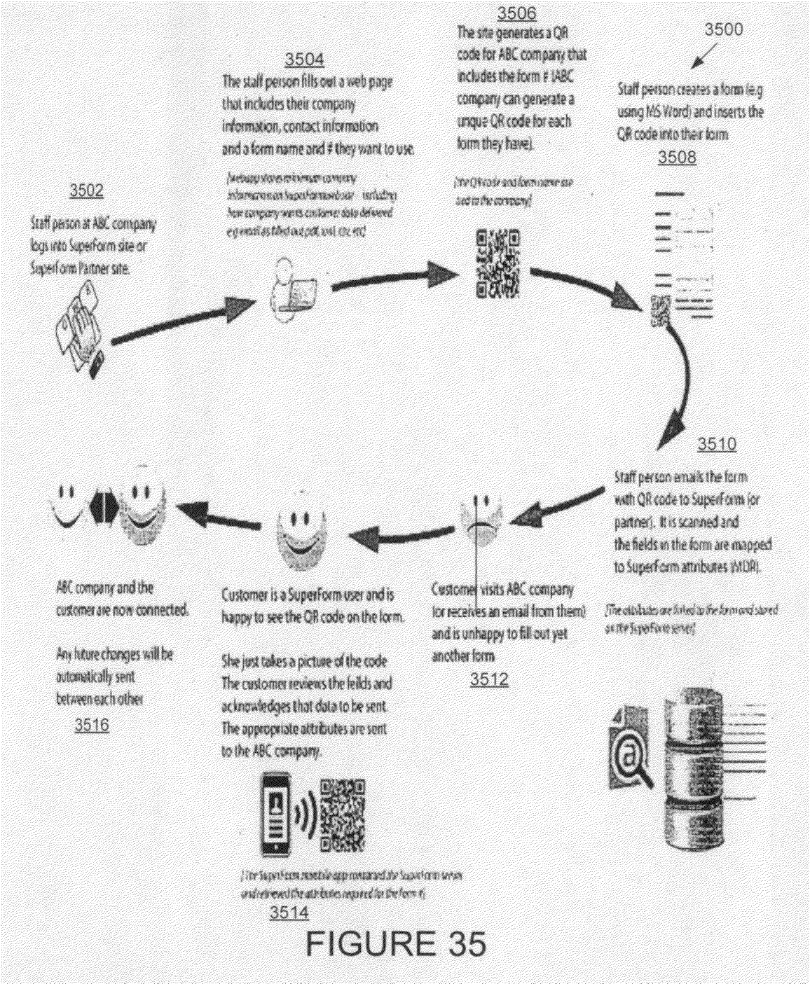

FIG. 35 depicts a flow diagram 3500 of an example of a method for universal form creation and distribution. In the example of FIG. 35, the flow diagram 3500 starts at module 3502, a staff person at ABC company logs into SuperForm site or Superform Partner site. In a specific implementation, a staff member associated with a universal form creator may use the universal form creation engine 104 to log in, through the computer readable medium 102, to a universal form portal associated with the universal form distribution engine 102.

In the example of FIG. 35, the flow diagram 3500 continues to module 3504, the staff person filling out a web page that includes their company information, contact information, and a form name and number that they want to use. In a specific implementation, the staff person may use the universal form creation engine 104 to include company information, contact information, and a form name and number that they want to use to the universal form distribution engine 102.

In the example of FIG. 35, the flow diagram 3500 continues to module 3506, the site generates a QR code for ABC company that includes a unique form number. In a specific implementation, the universal form distribution engine 102 may generate a universal form identifier for each form that is generated; the universal form identifier may comprise a QR code.

In the example of FIG. 35, the flow diagram 3500 continues to module 3508, the staff person creating a form and inserting the QR code into the form. In a specific implementation, the universal form creation engine 104 may insert the QR code into the form.

In the example of FIG. 35, the flow diagram 3500 continues to module 3510, the staff person emailing the form with the QR code to Superform or its partner, with the form being scanned and the fields in the form being mapped to Superform attributes. In a specific implementation, the universal form creation engine 104 may send a particular blank universal form to the universal form filler engine 108.

In the example of FIG. 35, the flow diagram 3500 continues to module 3512, a customer visiting ABC company or receiving an email from it, and unhappy to fill out yet another form. In a specific implementation, the universal form filler engine 108 may receive the particular blank universal form.

In the example of FIG. 35, the flow diagram 3500 continues to module 3514, the customer is a Superform user and is happy to see the QR code on the form; in this module, the customer takes a picture of the code, reviews the fields and acknowledges that data is to be sent; the appropriate attributes are sent to ABC company. In a specific implementation, the universal form filler engine 108 may recognize fields of the form that need to be filled, the recognition based on the universal form identifier. The universal form filler engine 108 may further automatically populate the fields of the form that need to be populated.

In the example of FIG. 35, the flow diagram 3500 continues to module 3516, the ABC company and the customer are now connected; all future changes will be automatically sent between each other. In a specific implementation, the universal form filler engine 108 and the universal form creation engine 104 may now interact with one another.

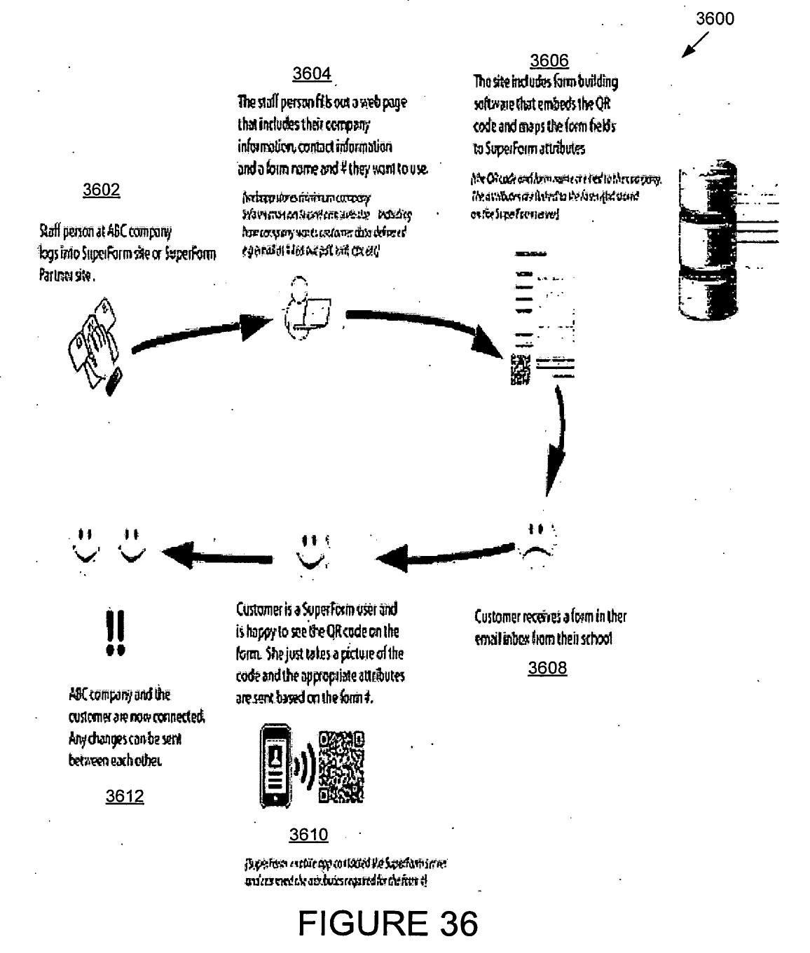

FIG. 36 depicts a flow diagram 3600 of an example of a method for universal form creation and distribution. In the example of FIG. 36, the flow diagram 3600 starts at module 3602, a staff person at ABC company logs into SuperForm site or Superform Partner site. In a specific implementation, a staff member associated with a universal form creator may use the universal form creation engine 104 to log in, through the computer readable medium 102, to a universal form portal associated with the universal form distribution engine 102.

In the example of FIG. 36, the flow diagram 3600 continues to module 3604, the staff person filling out a web page that includes their company information, contact information, and a form name and number that they want to use. In a specific implementation, the staff person may use the universal form creation engine 104 to include company information, contact information, and a form name and number that they want to use to the universal form distribution engine 102.

In the example of FIG. 36, the flow diagram 3600 continues to module 3606, the site includes form building software that embeds a QR code and maps the form fields to Superform attributes. In a specific implementation, the universal form distribution engine 102 may include a set of universal form libraries that include a universal form identifier for each form that is generated; the universal form identifier may comprise a QR code.

In the example of FIG. 36, the flow diagram 3600 continues to module 3608, the customer receives a form in their inbox from their school. In a specific implementation, the universal form filler engine 108 may receive the particular blank universal form. In a specific implementation, the universal form filler engine 108 may recognize fields of the form that need to be filled, the recognition based on the universal form identifier. The universal form filler engine 108 may further automatically populate the fields of the form that need to be populated.

In the example of FIG. 36, the flow diagram 3600 continues to module 3610, the customer is a Superform user and is happy to see the QR code on the form; in this module, the customer takes a picture of the code, reviews the fields and acknowledges that data is to be sent; the appropriate attributes are sent to ABC company.

In the example of FIG. 36, the flow diagram 3600 continues to module 3612, the ABC company and the customer are now connected; all future changes will be automatically sent between each other. In a specific implementation, the universal form filler engine 108 and the universal form creation engine 104 may now interact with one another.

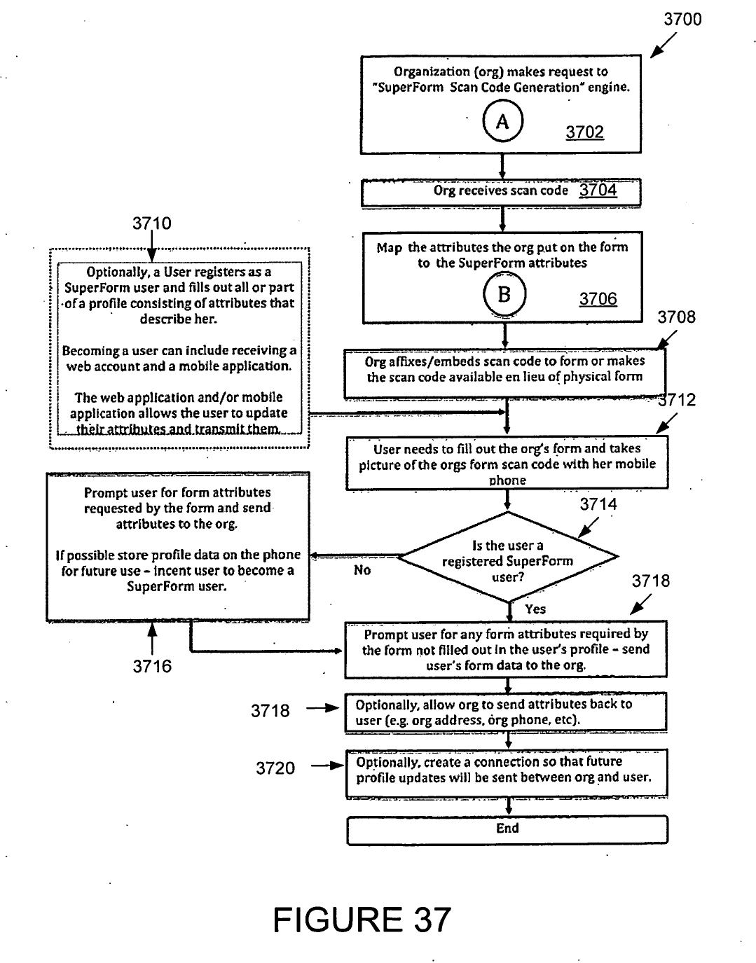

FIG. 37 depicts a flow diagram 3700 of an example of a method for universal form creation and distribution. In the example of FIG. 37, the flow diagram 3700 starts at module 3702, the organization making a request to “Superform Scan Code Generation” engine (i.e., a universal form identifier management engine). In a specific implementation, the universal form creation engine 104 may make a request to the universal form distribution engine 102 to generate a universal form identifier. The universal form identifier may be a visual identifier, such as a QR code. In a specific implementation, the universal form identifier management engine 311 (shown in FIG. 3) may provide the universal form identifier. The universal form identifier may define one or more attributes the universal form creation engine 104 indicates should be in a blank universal form that the universal form distribution engine 102 is to generate.

In the example of FIG. 37, the flow diagram 3700 continues to module 3704, the organization receiving the scan code. In a specific implementation, the universal form creation engine 104 may receive the universal form identifier, e.g., the QR code from the universal form distribution engine 102. Based on the visual identifier, the universal form creation engine 104 may provide one or more attributes to the universal form distribution engine 102 for creating a particular blank universal form.

In the example of FIG. 37, the flow diagram 3700 continues to module 3706, mapping the attributes put on the form to the SuperForm attributes. In a specific implementation, the universal form distribution engine 102 may map attributes the universal form creation engine 104 indicated should be in the particular blank universal form to attributes that are actually put into the particular blank universal form.

In the example of FIG. 37, the flow diagram 3700 continues to module 3708, where the organization affixes or embeds the scan code to the form or makes the scan code available in lieu of the physical form. In a specific implementation, the universal form creation engine 104 may affix or embed the universal form identifier into the particular blank universal form or makes the universal form identifier available instead of the particular blank universal form.

In the example of FIG. 37, the flow diagram 3700 continues to module 3710, where, optionally, a user registers as a SuperForm user and fills out all or part of a profile consisting of attributes that describe the user. In a specific implementation, a universal form filler using the universal form filler engine 108 may register as a SuperForm user and fill out all or part of a profile consisting of attributes that describe the user.

In the example of FIG. 37, the flow diagram 3700 continues to module 3712, where the user fills out the organization's form and takes a picture of the organization's form scan code with the user's mobile phone. In a specific implementation, the universal form filler engine 108 may fill out the particular blank universal form and take a picture of the universal form identifier associated with the particular blank universal form using the image capture device associated with the universal form filler engine 108.

In the example of FIG. 37, the flow diagram 3700 continues to decision point 3714, determining whether the user is a registered SuperForm user. In a specific implementation, the universal form distribution engine 102 may determine whether the universal form filler associated with the universal form filler engine 108 has an existing universal form filler account. If so, the method 3700 may proceed to module 3718. If not, the method may proceed to module 3716.

In the example of FIG. 37, the flow diagram 3700 continues to module 3716, prompting the user for form attributes requested by the form and sending the attributes to the organization. In a specific implementation, the universal form filler engine 108 may prompt the universal form filler for form attributes requested by the form and sending the attributes to the organization. The form attributes may include automatically populated information retrieved from the universal form filler's profile. In some embodiments, the universal form filler engine 108 may store the profile data on local datastores.

In the example of FIG. 37, the flow diagram 3700 continues to module 3718, prompting the user for any form attributes required by the form that are not filled out by the user's profile. In a specific implementation, the universal form filler engine 108 may prompt the universal form filler for any form attributes required by the form that are not filled out by the user's profile.

In the example of FIG. 37, the flow diagram 3700 continues to module 3720, allowing the organization to send attributes back to the user. In a specific implementation, the universal form distribution engine 102 may allow the universal form creation engine 104 to end attributes back to the universal form filler engine 108. Examples of attributes include the address, phone number, etc. of the universal form creator.

In the example of FIG. 37, the flow diagram 3700 continues to module 3722, creating a connection so that future profile updates will be sent between the organization and the user. In a specific implementation, the universal form distribution engine 102 may create a connection so that future profile updates will be sent between the universal form creation engine 104 and the universal form filler engine 108.

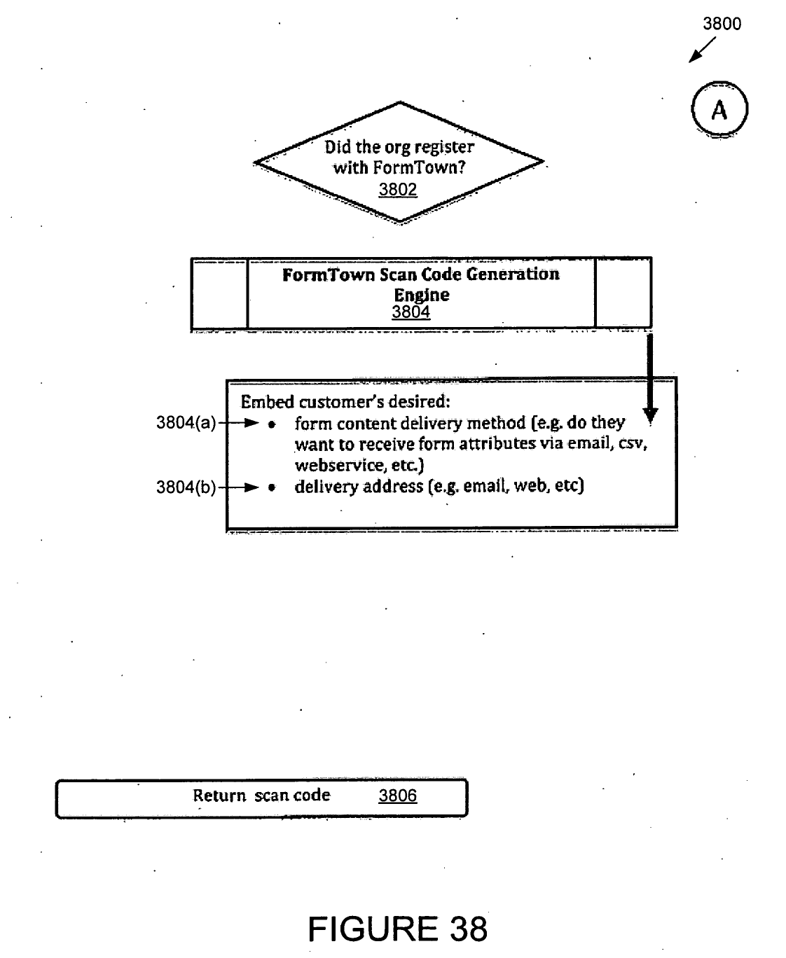

FIG. 38 depicts a flow diagram 3800 of an example of a method for generating a universal form identifier. In a specific implementation, the flow diagram 3800 may correspond to sub-modules of the module 3702, the organization making a request to “Superform Scan Code Generation” engine (i.e., a universal form identifier management engine), shown in FIG. 37.

In the example of FIG. 38, the flow diagram 3800 starts at module 3802, determining whether the organization registered with FormTown. In a specific implementation, the universal form distribution engine 102 may determine whether a form creator associated with the universal form creation engine 104 has registered with universal form distribution services provided by the universal form distribution engine 102.

In the example of FIG. 38, the flow diagram 3800 continues to module 3804, executing the FormTown ScanCode Generation Engine. In a specific implementation, the universal form distribution engine 102 may, first, embed a universal form filler's desired form content delivery method (e.g., whether the universal form filler wants to receive form attributes via email, csv, web service, etc.), in module 3804(a). In a specific implementation, the universal form distribution engine 102 may, then, embed the universal form filler's delivery address (e.g., email, web, etc.), in module 3804(b).

In the example of FIG. 38, the flow diagram 3800 continues to module 3806, returning a scan code. In a specific implementation, the universal form distribution engine 102 may include a universal form identifier in the form of a scan code (e.g., a QR code).

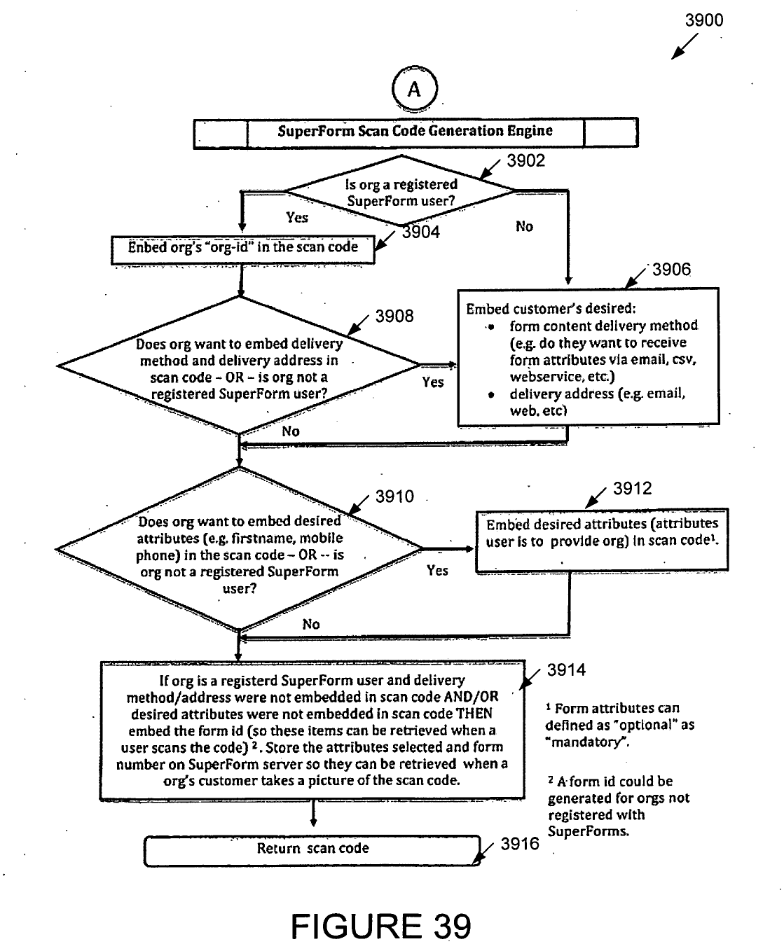

FIG. 39 depicts a flow diagram 3900 of an example of a method for generating a universal form identifier. In a specific implementation, the flow diagram 3900 may correspond to sub-modules of the module 3702, the organization making a request to “Superform Scan Code Generation” engine (i.e., a universal form identifier management engine), shown in FIG. 37.

In the example of FIG. 39, the flow diagram 3900 starts at decision point 3902, determining whether an organization is a registered SuperForm user. In a specific implementation, the universal form distribution engine 102 may determine whether a form creator associated with the universal form creation engine 104 has registered with universal form distribution services provided by the universal form distribution engine 102. If the form creator has registered for universal form distribution services, the flow diagram 3900 may proceed to module 3904, and if the form creator has not registered for universal form distribution services, the flow diagram 3900 proceeds to decision point 3906.

In the example of FIG. 39, the flow diagram 3900 continues to module 3904, embedding the organization's identifier into the scan code. In a specific implementation, the universal form distribution engine 102 may embed the identifier of the form creator into a universal form identifier, such as a QR code.

In the example of FIG. 39, the flow diagram 3900 continues to decision point 3906, embedding the customer's desired form content delivery method and the customer's delivery address. In a specific implementation, the universal form distribution engine 102 may embed a universal form filler's desired form content delivery method (e.g., whether the universal form filler wants to receive form attributes via email, csv, web service, etc.), and then, embed the universal form filler's delivery address (e.g., email, web, etc.). The flow diagram 3900 proceeds to decision point 3910.

In the example of FIG. 39, the flow diagram 3900 continues to decision point 3908, determining whether the organization want to embed the delivery method and delivery address in the scan code or determining if the organization is not a registered SuperForm user. In a specific implementation, the universal form distribution engine 102 may perform this determination. If the determination is positive, the flow diagram 3900 proceeds to decision point 3906. If the determination is negative, the flow diagram 3900 proceeds to decision point 3910.

In the example of FIG. 39, the flow diagram 3900 continues to decision point 3910, determining whether the organization wants to embed desired attributes in the scan code or determining that the organization is not a registered SuperForm user. In a specific implementation, the universal form distribution engine 102 may make this determination.

In the example of FIG. 39, the flow diagram 3900 continues to module 3912, embedding desired attributes in the scan code. In a specific implementation, the universal form distribution engine 102 may embed the desired attributes in the universal form identifier.

In the example of FIG. 39, the flow diagram 3900 continues to module 3914, embedding the form id if the organization is a registered SuperForm user and the delivery method/address were not embedded in the scan code and/or desired attributes were not embedded in the scan code. In a specific implementation, the universal form distribution engine 102 may embed the form id if the organization is a registered SuperForm user and the delivery method/address were not embedded in the scan code and/or desired attributes were not embedded in the scan code.

In the example of FIG. 39, the flow diagram 3900 continues to module 3916, returning the scan code. In a specific implementation, the universal form distribution engine 102 may include a universal form identifier in the form of a scan code (e.g., a QR code).

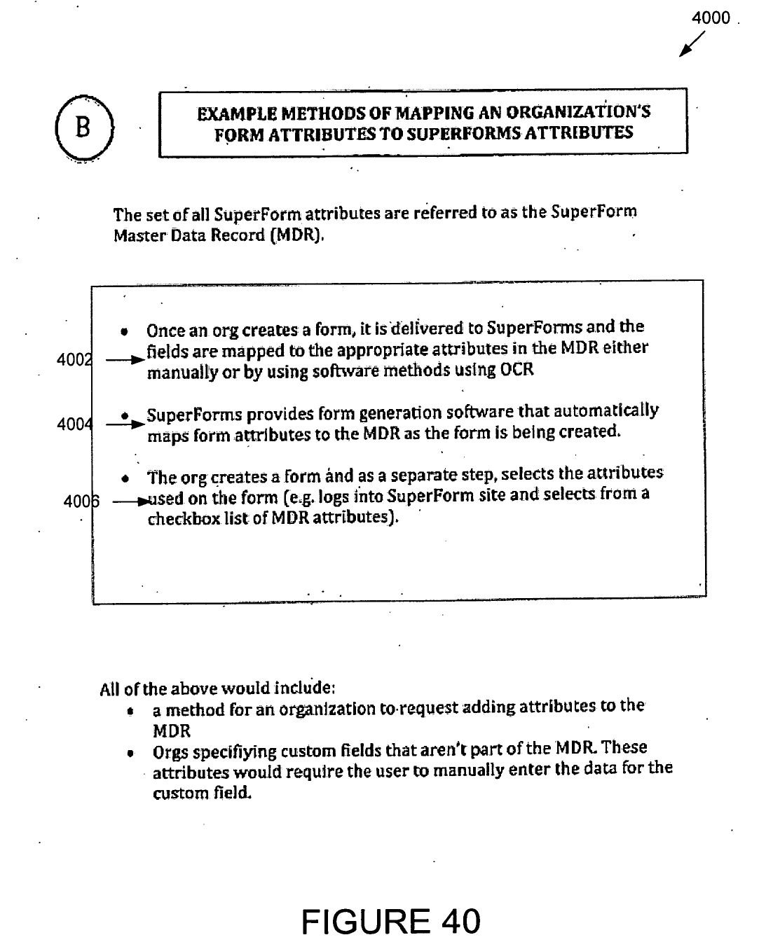

FIG. 40 depicts a flow diagram 4000 of an example of a method for universal form creation and distribution. In a specific implementation, the flow diagram 4000 may correspond to sub-modules of the module 3706, mapping the attributes the organization put on the form to the SuperForm attributes, shown in FIG. 37.

In the example of FIG. 40, the flow diagram 4000 starts at module 4002, once an organization creates a form, the form is delivered to SuperForms and the fields are mapped to the appropriate attributes of a Master Data Record (MDR) manually or by using software method using Optical Character Recognition (OCR). In a specific implementation, the universal form distribution engine 102 may receive and/or recognize a blank universal form.

In the example of FIG. 40, the flow diagram 4000 continues to module 4004, SuperForms provides form generation software that automatically maps form attributes to the MDR as the form is being created. In a specific implementation, the universal form distribution engine 102 may provide form generation software that automatically maps form attributes to the MDR as the form is being created.

In the example of FIG. 40, the flow diagram 4000 continues to module 4006, the organization creates the form and as a separate step, selects the attributes used on the form (e.g., logs into SuperForm site and selects it from a checkbox list of MDR attributes). In a specific implementation, the universal form creation engine 104 may create the form and as a separate step, selects the attributes used on the form (e.g., logs into SuperForm site and selects it from a checkbox list of MDR attributes).

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general purpose computer selectively activated or reconfigured by a computer program stored in the computer. Such a computer program can be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

We claim:

1. A system comprising:
a blank universal form management datastore and a verified universal form management datastore;
a blank universal form management engine coupled to the blank universal form management datastore;
a verified universal form management engine coupled to the verified universal form management datastore and to the blank universal form management engine;
wherein, in operation:
the blank universal form management engine retrieves a particular blank universal form based on a universal form template, the particular blank universal form having a universal form identifier, and the particular blank universal form created by a universal form creator;
the blank universal form management engine provides the particular blank universal form to a universal form filler;
the verified universal form management engine receives a verified form from the universal form filler, the verified form corresponding to the particular blank universal form;
the verified universal form management engine provides the verified form to the universal form creator.

2. The system of claim 1, further comprising a universal form identifier management datastore and a universal form identifier management engine coupled to the universal form identifier management datastore and the blank universal form management engine;
wherein, in operation the universal form identifier management engine:
retrieves the universal form identifier from the universal form identifier management datastore;
embeds the universal form identifier in the particular blank universal form.

3. The system of claim 1 wherein the universal form identifier comprises an image that represents the universal form identifier.

4. The system of claim 3 wherein the image comprises a Quick Response (QR) code that provides contents of the particular blank universal form.

5. The system of claim 1, further comprising a universal form filler profile management datastore and a universal form filler profile management engine coupled to the universal form filler profile management datastore and to the blank universal form management engine;
wherein, in operation, the universal form filler profile management engine:
selects a set of subscribers for the particular blank universal form, the set of subscribers including the universal form filler;
instructs the blank universal form management engine to customize at least a portion of the particular blank universal form for the set of subscribers.

6. The system of claim 1 wherein the verified form comprises automatically populated information provided by the universal form filler.

7. The system of claim 6 wherein the automatically populated information comprises information associated with the universal form filler and maintained in a universal form filler account.

8. The system of claim 1 wherein the verified form comprises a verification field completed by the universal form filler.

9. The system of claim 8 wherein the verification field comprises automatically populated information provided by the universal form filler.

10. A method comprising:
retrieving a particular blank universal form based on a universal form template, the particular blank universal form having a universal form identifier, and the particular blank universal form created by a universal form creator;
providing the particular blank universal form to a universal form filler;
receiving a verified form from the universal form filler, the verified form corresponding to the particular blank universal form;
providing the verified form to the universal form creator.

11. The method of claim 10, further comprising:
retrieving the universal form identifier from a universal form identifier datastore;
embedding the universal form identifier in the particular blank universal form.

12. The method of claim 10 wherein the universal form identifier comprises an image that represents the universal form identifier.

13. The method of claim 12 wherein the image comprises a Quick Response (QR) code that provides contents of the particular blank universal form.

14. The method of claim 10 further comprising:
selecting a set of subscribers for the particular blank universal form, the set of subscribers including the universal form filler;
providing an instruction to customize at least a portion of the particular blank universal form for the set of subscribers.

15. The method of claim 10 wherein the verified form comprises automatically populated information provided by the universal form filler.

16. The method of claim 15 wherein the automatically populated information comprises information associated with the universal form filler and maintained in a universal form filler account.

17. The method of claim 10 wherein the verified form comprises a verification field completed by the universal form filler.

18. The method of claim 17 wherein the verification field comprises automatically populated information provided by the universal form filler.

19. A system comprising:
means for retrieving a particular blank universal form based on a universal form template, the particular blank universal form having a universal form identifier, and the particular blank universal form created by a universal form creator;
means for providing the particular blank universal form to a universal form filler;
means for receiving a verified form from the universal form filler, the verified form corresponding to the particular blank universal form;
means for providing the verified form to the universal form creator.
